(19) United States
(12) Patent Application Publication
(10) Pub. No.: US 2022/0266548 A1
(43) Pub. Date: Aug. 25, 2022

(54) PART ELEMENT FOR A WIND TURBINE BLADE AND METHOD FOR MANUFACTURING A PART ELEMENT FOR A WIND TURBINE BLADE

(71) Applicant: Blade Dynamics Limited, Eastleigh, Hampshire (GB)

(72) Inventors: Paul Damian Michael TODD, Eastleigh, Hampshire (GB); Mark HANCOCK, Eastleigh, Hampshire (GB)

(21) Appl. No.: 17/629,141

(22) PCT Filed: Jul. 24, 2020
(86) PCT No.: PCT/EP2020/070565

§ 371 Date: Jan. 21, 2022

(30) Foreign Application Priority Data
Jul. 24, 2019 (GB) 1910566.7

(51) Int. Cl. B29C 70/48; B29C 70/54; B29C 70/52

(52) U.S. Cl. CPC B29C 70/48; B29C 70/543; B29C 70/541; B29C 70/523; B29L 2031/085

(57) ABSTRACT

Disclosed is a part element for a wind turbine blade and a method for manufacturing a part element. The part element comprises a primary sheet having a primary first side and a primary second side. The part element comprises a first fibre thread extending in a primary first direction and forming a first primary loop on the primary first side of the primary sheet from a primary first L1 point to a primary first L2 point. The part element comprises a second fibre thread extending in a primary second direction and forming a second primary loop extending from a primary second L1 point at the primary first side of the primary sheet to a primary second L2 point at the primary first side. A first pre-shaped element is positioned between the first fibre thread and the second fibre thread.

The present disclosure relates to wind turbine blades and manufacture of wind turbine blades. More specifically, the present disclosure pertains to the field of manufacturing of parts of a wind turbine blade, such as reinforcement parts of blade shells, such as blade shell parts, shear webs, spar beams, spar caps etc.

### BACKGROUND

Wind turbine blades of fibre-reinforced polymer and in particular the aerodynamic shells of wind turbine blades are usually manufactured in moulds, where the pressure side and the suction side of the blade are manufactured separately by arranging glass fibre mats and/or other fibre-reinforcement material, such as carbon fibre, in each of the two moulds. Afterwards, one of the two halves is turned upside down and positioned on top of the other of the two halves, and the two halves are adhered together. The blade parts may be positioned on top of each other by turning and repositioning the complete half mould.

A wind turbine blade and/or components of the wind turbine blade, such as webs and/or shells, may be manufactured by infusing fibres, such as glass fibre mats and/or carbon fibre mats with a resin, such as polyester or epoxy. Infusion of the fibres may be provided by vacuum assisted resin transfer moulding (VARTM).

As wind turbines and wind turbine blades increase in size, the blade loads, i.e. strains, bending moments, peel loads etc., increase. For this and other reasons, precision in placement of component is of an increasing importance.

There is a desire to improve the process of manufacturing parts for a wind turbine blade and to reduce the total manufacturing time for a wind turbine blade. More specifically, it is a desire to reduce the in-mould manufacturing time for wind turbine blades to provide a faster turnaround time. By manufacturing as many parts offline and laying the pre-formed part in the mould, the in-mould manufacturing time can be reduced.

Furthermore, a more precise and easier way of manufacturing parts comprising pre-shaped elements, such as pultruded members, would also reduce the total manufacturing time and improve the quality of the wind turbine blades.

### SUMMARY OF THE INVENTION

It is an object of the present disclosure to provide a part element for a wind turbine blade and a method for manufacturing a part for a wind turbine blade, which overcomes at least some of the disadvantages of the prior art.

In particular, it is an object of the present invention to provide a part element for a wind turbine blade and a method for manufacturing a part element for a wind turbine blade, which improves the process of positioning of components as well as facilitating decreased manufacturing time. Improvement in the process of positioning components may further decrease manufacturing variations and enhance mechanical properties of the assembled blade.

Thus, the present invention relates to a part element for a wind turbine blade. The part element comprises a primary sheet having a primary first side and a primary second side. The primary sheet may comprise fibres, e.g. the primary sheet may comprise fibres extending in a longitudinal direction and in a transverse direction. The part element, such as the primary sheet comprises one or more fibre threads, e.g. a first fibre thread extending in a primary first direction. The one or more fibre threads forms one or more loops on the primary first side of the primary sheet. The first fibre thread forms a first primary loop on the primary first side of the primary sheet from a primary first L1 point to a primary first L2 point. The first fibre thread, such as a first end of the first fibre thread, is anchored to the primary sheet.

The first fibre thread is anchored, such as to prevent movement of the first fibre end relative to the primary sheet, such as relative to other fibres of the primary sheet. The first fibre thread may be anchored by creating a first stitch, e.g. where the first stitch is a backstitch. A stitch may be obtained when the fibre thread is sewn through the sheet. A backstitch may be obtained by sewing the fibre thread through the sheet, e.g. from the primary second side, at a point of entry and returning though the sheet, e.g. to the primary second side, at a point of exit, wherein the point of exit is more proximal to the first end of the fibre thread than the point of entry. A backstitch may lock the fibre thread. Two backstitches may lock the fibre thread, e.g. such that loops between the two backstitches may maintain their sizes.

An alternative to a backstitch may be a running stitch. A running stitch may be obtained by sewing the fibre thread through the sheet, e.g. from the primary second side, at a point of entry and returning through the sheet, e.g. to the primary second side, at a point of exit, wherein the point of exit is more distal to the first end of the fibre thread than the point of entry. A running stitch may not limit a pull of the fibre thread, e.g. such that loops confined by running stitches may change in size.

Backstitches may have the advantage of providing fixed sizes of the loops. Running stitches may have the advantage of variable loop sizes. Any number of stitches of any type may be provided between the loops.

Also disclosed is a method for manufacturing a part element for a wind turbine blade. The method comprises providing a primary sheet having a primary first side and a primary second side. The primary sheet may comprise fibres, e.g. the primary sheet may comprise fibres extending in a longitudinal direction and in a transverse direction. The method may comprise providing one or more fibre threads, such as a first fibre thread. The primary sheet may comprise the first fibre thread. The first fibre thread may extend in a primary first direction. The first fibre thread forms a first primary loop on the primary first side of the primary sheet. from a primary first L1 point to a primary first L2 point. The first fibre thread, such as a first end of the first fibre thread, is anchored to the primary sheet.

It is an advantage of the present disclosure that an easier way of laying up layers may be provided, as the part element provides a more flexible and easier way of controlling the position between elements. Particularly, looped fibres may provide for restraining of elements, thereby providing a way of better controlling and/or restricting movement between elements.

It is a further advantage of the present disclosure that the part element may allow for high drapability and ability to adapt better to curved surfaces than current solutions.

It is an even further advantage of the present disclosure that layers may be laid up outside the blade shell mould, since the disclosed part element facilitates an improved method of transferring pre-shaped elements.

The first fibre thread may extend alternatingly on the primary first side and the primary second side in the primary first direction. The first fibre thread may extend at least partly on the primary second side of the primary sheet from the primary first L1 point to a primary first L0 point. The first fibre thread may extend at least partly on the primary second side of the primary sheet from the primary first L2 point to a primary first L3 point. The first fibre thread may form a first secondary loop on the primary first side of the primary sheet from the primary first L3 point to a primary first L4 point. Alternatively or additionally, the first fibre thread may form a first tertiary loop on the primary first side of the primary sheet from a primary first L5 point to a primary first L6 point.

The primary first direction may be parallel to the longitudinal direction of the primary sheet. Alternatively, the primary first direction may be perpendicular to the longitudinal direction of the primary sheet, e.g. the primary first direction may be parallel to the transverse direction of the primary sheet.

The part element, e.g. the primary sheet of the part element, may comprise a second fibre thread extending in a primary second direction and forming a second primary loop on the primary first side of the primary sheet from a primary second L1 point to a primary second L2 point. The first fibre thread and the second fibre thread may extend substantially parallel. The second fibre thread, such as a first end of the second fibre thread, may be anchored to the primary sheet.

The second fibre thread may extend alternatingly on the primary first side and the primary second side in the primary second direction. The second fibre thread may extend at least partly on the primary second side of the primary sheet from the primary second L1 point to a primary second L0 point. The second fibre thread may extend at least partly on the primary second side of the primary sheet from the primary second L2 point to a primary second L3 point. The second fibre thread may form a second secondary loop on the primary first side of the primary sheet from a primary second L3 point to a primary second L4 point. Alternatively or additionally, the second fibre thread may form a second tertiary loop on the primary first side of the primary sheet from a primary second L5 point to a primary second L6 point.

The first fibre thread and the second fibre thread may extend parallel on the primary first side. The first fibre thread and the second fibre thread may extend parallel on the primary second side. The primary second direction may be parallel to the longitudinal direction of the primary sheet. Alternatively, the primary second direction may be perpendicular to the longitudinal direction of the primary sheet, e.g. the primary second direction may be parallel to the transverse direction of the primary sheet. The primary second direction may be parallel or perpendicular to the primary first direction.

The part element, e.g. the primary sheet of the part element may comprise a third fibre thread extending in a primary third direction. The third fibre thread may form a third primary loop on the primary first side of the primary sheet from a primary third T1 point to a primary third T2 point. The first fibre thread and the third fibre thread may extend substantially perpendicular. The second fibre thread and the third fibre thread may extend substantially perpendicular. A first end of the third fibre thread may be anchored to the primary sheet.

The third fibre thread may extend alternatingly on the primary first side and the primary second side in the primary third direction. The third fibre thread may extend at least partly on the primary second side of the primary sheet from the primary third T1 point to a primary third T0 point. The third fibre thread may extend at least partly on the primary second side of the primary sheet from the primary third T2 point to a primary third T3 point. The third fibre thread may form a third secondary loop on the primary first side of the primary sheet from the primary third T3 point to a primary third T4 point. Alternatively or additionally, the third fibre thread may form a third tertiary loop on the primary first side of the primary sheet from a primary third T5 point to a primary third T6 point.

The primary third direction may be parallel to the transverse direction of the primary sheet. Alternatively, the primary third direction may be perpendicular to the transverse direction of the primary sheet, e.g. the primary third direction may be parallel to the longitudinal direction of the primary sheet. The primary third direction may be perpendicular to the primary first direction and/or the primary second direction. The primary third direction may be different than the primary first direction and/or the primary second direction. The third primary loop may be located between the first fibre thread and the second fibre thread.

The part element, e.g. the primary sheet of the part element, may comprise a fourth fibre thread extending in a primary fourth direction. The fourth fibre thread may form a fourth primary loop on the primary first side of the primary sheet from a primary fourth T1 point to a primary fourth T2 point.

The fourth fibre thread may extend alternatingly on the primary first side and the primary second side in the primary fourth direction. The fourth fibre thread may extend at least partly on the primary second side of the primary sheet from the primary fourth T1 point to a primary fourth T0 point. The fourth fibre thread may extend at least partly on the primary second side of the primary sheet from the primary fourth T2 point to a primary fourth T3 point. The fourth fibre thread may form a fourth secondary loop on the primary first side of the primary sheet from the primary fourth T3 point to a primary fourth T4 point. Alternatively or additionally, the fourth fibre thread may form a fourth tertiary loop on the primary first side of the primary sheet from a primary fourth T5 point to a primary fourth T6 point.

The primary fourth direction may be parallel to the transverse direction of the primary sheet. Alternatively, the primary fourth direction may be perpendicular to the transverse direction of the primary sheet, e.g. the primary fourth direction may be parallel to the longitudinal direction of the primary sheet. The primary fourth direction may be perpendicular to the primary first direction and/or the primary second direction. The primary fourth direction may be parallel to the primary third direction. The primary fourth direction may be different than the primary first direction and/or the primary second direction.

The part element, e.g. the primary sheet of the part element, may comprise a fifth fibre thread extending in a primary fifth direction. The fifth fibre thread may form a fifth primary loop on the primary first side of the primary sheet from a primary fifth L1 point to a primary fifth L2 point.

The fifth fibre thread may extend alternatingly on the primary first side and the primary second side in the primary fourth direction. The fifth fibre thread may extend at least partly on the primary second side of the primary sheet from the primary fifth L1 point to a primary fifth L0 point. The fifth fibre thread may extend at least partly on the primary second side of the primary sheet from the primary fifth L2 point to a primary fifth L3 point. The fifth fibre thread may form a fifth secondary loop on the primary first side of the primary sheet from the primary fifth L3 point to a primary fifth L4 point. Alternatively or additionally, the fifth fibre thread may form a fifth tertiary loop on the primary first side of the primary sheet from a primary fifth L5 point to a primary fifth L6 point.

The primary fifth direction may be parallel to the longitudinal direction of the primary sheet. Alternatively, the primary fifth direction may be perpendicular to the longitudinal direction of the primary sheet, e.g. the primary fifth direction may be parallel to the transverse direction of the primary sheet. The primary fifth direction may be parallel to the primary first direction and/or the primary second direction. The primary fifth direction may be perpendicular to the primary third direction and/or the primary fourth direction. The primary fifth direction may be different than the primary third direction and/or the primary fourth direction.

The second fibre thread and/or the third fibre thread and/or the fourth fibre thread and/or the fifth fibre thread may be anchored, such as to prevent movement of the first fibre end relative to the primary sheet, such as relative to other fibres of the primary sheet.

The first fibre thread and/or second fibre thread and/or third fibre thread and/or fourth fibre thread and/or fifth fibre thread may comprise materials such as glass fibre, carbon fibre, cotton, linen, flax, hemp, synthetic filaments or any other similar material.

The part element may comprise a secondary sheet. The method may comprise providing the secondary sheet. The secondary sheet may comprise fibres, e.g. the secondary sheet may comprise fibres extending in a longitudinal direction and/or in a transverse direction. The secondary sheet may have a secondary first side and a secondary second side.

The secondary sheet and the primary sheet may be arranged such that the primary first side of the primary sheet is facing the secondary second side of the secondary sheet. The first primary loop may be provided to extend to the secondary first side of the secondary sheet. The second primary loop may be provided to extend to the secondary first side of the secondary sheet.

The secondary sheet may comprise a first primary slit extending in a secondary first direction from a secondary first L1 point to a secondary first L2 point. The first primary slit may be configured to receive part of the first fibre thread, e.g. the first primary loop or at least a part of the first primary loop. The first primary loop may extend through the first primary slit.

The secondary sheet may comprise a first secondary slit extending in the secondary first direction from a secondary first L3 point to a secondary first L4 point. The first secondary slit may be configured to receive part of the first fibre thread, e.g. the first secondary loop or at least a part of the first secondary loop. The first secondary loop may extend through the first secondary slit. The secondary sheet may comprise a first tertiary slit extending in the secondary first direction from a secondary first L5 point to a secondary first L6 point. The first tertiary slit may be configured to receive part of the first fibre thread, e.g. the first tertiary loop or at least a part of the first tertiary loop. The first tertiary loop may extend through the first tertiary slit.

The secondary sheet may comprise a second primary slit. The second primary slit may extend in a secondary second direction. The second primary slit may extend from a secondary second L1 point to a secondary second L2 point. The second primary slit may be configured to receive part of the second fibre thread, e.g. the second primary loop or at least a part of the second primary loop. The second primary loop may extend through the second primary slit. The secondary sheet may comprise a second secondary slit extending in the secondary second direction from a secondary second L3 point to a secondary second L4 point. The second secondary slit may be configured to receive part of the second fibre thread, e.g. the second secondary loop or at least a part of the second secondary loop. The second secondary loop may extend through the second secondary slit. The secondary sheet may comprise a second tertiary slit extending in the secondary second direction from a secondary second L5 point to a secondary second L6 point. The second tertiary slit may be configured to receive part of the second fibre thread, e.g. the second tertiary loop or at least a part of the second tertiary loop. The second tertiary loop may extend through the second tertiary slit. The secondary first direction and the secondary second direction may be substantially parallel. The first primary slit, the first secondary slit, the first tertiary slit, the second primary slit, the second secondary slit, and/or the second tertiary slit may extend substantially parallel.

The secondary sheet may comprise a third primary slit. The third primary slit may extend in a secondary third direction. The third primary slit may extend from a secondary third T1 point to a secondary third T2 point. The third slit may be configured to receive part of the third fibre thread, e.g. the third primary loop or at least a part of the third primary loop. The third primary loop may extend through the third primary slit. The secondary sheet may comprise a third secondary slit extending in the secondary third direction from a secondary third T3 point to a secondary third T4 point. The third secondary slit may be configured to receive part of the third fibre thread, e.g. the third secondary loop or at least a part of the third secondary loop. The third secondary loop may extend through the third secondary slit. The secondary sheet may comprise a third tertiary slit extending in the secondary third direction from a secondary third T5 point to a secondary third T6 point. The third tertiary slit may be configured to receive part of the third fibre thread, e.g. the third tertiary loop or at least a part of the third tertiary loop. The third tertiary loop may extend through the third tertiary slit. The secondary first direction and the secondary third direction may be substantially perpendicular. The secondary second direction and the secondary third direction may be substantially perpendicular. The third primary slit may extend in a direction different than the secondary second direction and/or the secondary first direction.

The secondary sheet may comprise a fourth primary slit. The fourth primary slit may extend in a secondary fourth direction. The fourth primary slit may extend from a secondary fourth T1 point to a secondary fourth T2 point. The fourth suit may be configured to receive part of the fourth fibre thread, e.g. the fourth primary loop or at least a part of the fourth primary loop. The fourth primary loop may extend through the fourth primary slit. The secondary sheet may comprise a fourth secondary slit extending in the secondary fourth direction from a secondary fourth T3 point to a secondary fourth T4 point. The fourth secondary slit may be configured to receive part of the fourth fibre thread, e.g. the fourth secondary loop or at least a part of the fourth secondary loop. The fourth secondary loop may extend through the fourth secondary slit. The secondary sheet may comprise a fourth tertiary slit extending in the secondary fourth direction from a secondary fourth T5 point to a secondary fourth T6 point. The fourth tertiary slit may be configured to receive part of the fourth fibre thread, e.g. the fourth tertiary loop or at least a part of the fourth tertiary loop. The fourth tertiary loop may extend through the fourth tertiary slit. The secondary first direction and the secondary fourth direction may be substantially perpendicular. The secondary second direction and the secondary fourth direction may be substantially perpendicular. The secondary third direction and the secondary fourth direction may be substantially parallel. The fourth primary slit may extend in a direction different than the secondary second direction and/or the secondary first direction, e.g. the secondary fourth direction may be perpendicular to the secondary second direction and/or the secondary first direction. The fourth primary slit and the third primary slit may extend substantially parallel.

The secondary sheet may comprise a fifth primary silt. The fifth primary slit may extend in a secondary fifth direction. The fifth primary slit may extend from a secondary fifth L1 point to a secondary fifth L2 point. The fifth primary slit may be configured to receive part of the fifth fibre thread, e.g. the fifth primary loop or at least a part of the fifth primary loop. The fifth primary loop may extend through the fifth primary slit. The secondary sheet may comprise a fifth secondary slit extending in the secondary fifth direction from a secondary fifth L3 point to a secondary fifth L4 point. The fifth secondary sit may be configured to receive part of the fifth fibre thread, e.g. the fifth secondary loop or at least a part of the fifth secondary loop. The fifth secondary loop may extend through the fifth secondary silt. The secondary sheet may comprise a fifth tertiary slit extending in the secondary fifth direction from a secondary fifth L5 point to a secondary fifth L6 point. The fifth tertiary silt may be configured to receive part of the fifth fibre thread, e.g. the fifth tertiary loop or at least a part of the fifth tertiary loop. The fifth tertiary loop may extend through the fifth tertiary slit. The secondary first direction and the secondary fifth direction may be substantially parallel. The secondary second direction and the secondary fifth direction may be substantially parallel. The secondary third direction and the secondary fifth direction may be substantially perpendicular. The secondary fourth direction and the secondary fifth direction may be substantially perpendicular. The fifth primary slit and the first primary slit may extend substantially parallel.

The secondary sheet may have a secondary first side and a secondary second side. The primary first side of the primary sheet may be arranged to face the secondary sheet, e.g. such as to face the secondary second side of the secondary sheet.

The primary sheet and the secondary sheet may be arranged such that the primary first L1 point of the primary sheet is aligned with the secondary first L1 point of the secondary sheet and/or such that the primary first L2 point of the primary sheet is aligned with the secondary first L2 point of the secondary sheet. The primary sheet and the secondary sheet may be arranged such that the primary first L3 point of the primary sheet is aligned with the secondary first L3 point of the secondary sheet and/or such that the primary first L4 point of the primary sheet is aligned with the secondary first L4 point of the secondary sheet. The primary sheet and the secondary sheet may be arranged such that the primary first L5 point of the primary sheet is aligned with the secondary first L5 point of the secondary sheet and/or such that the primary first L6 point of the primary sheet is aligned with the secondary first L6 point of the secondary sheet.

The primary sheet and the secondary sheet may be arranged such that the primary second L1 point of the primary sheet is aligned with the secondary second L1 point of the secondary sheet and/or such that the primary second L2 point of the primary sheet is aligned with the secondary second L2 point of the secondary sheet. The primary sheet and the secondary sheet may be arranged such that the primary second L3 point of the primary sheet is aligned with the secondary second L3 point of the secondary sheet and/or such that the primary second L4 point of the primary sheet is aligned with the secondary second L4 point of the secondary sheet. The primary sheet and the secondary sheet may be arranged such that the primary second L5 point of the primary sheet is aligned with the secondary second L5 point of the secondary sheet and/or such that the primary second L6 point of the primary sheet is aligned with the secondary second L6 point of the secondary sheet.

The primary sheet and the secondary sheet may be arranged such that the primary third L1 point of the primary sheet is aligned with the secondary third L1 point of the secondary sheet and/or such that the primary third L2 point of the primary sheet is aligned with the secondary third L2 point of the secondary sheet. The primary sheet and the secondary sheet may be arranged such that the primary third L3 point of the primary sheet is aligned with the secondary third L3 point of the secondary sheet and/or such that the primary third L4 point of the primary sheet is aligned with the secondary third L4 point of the secondary sheet. The primary sheet and the secondary sheet may be arranged such that the primary third L5 point of the primary sheet is aligned with the secondary third L5 point of the secondary sheet and/or such that the primary third L6 point of the primary sheet is aligned with the secondary third L6 point of the secondary sheet.

The primary sheet and the secondary sheet may be arranged such that the primary fourth L1 point of the primary sheet is aligned with the secondary fourth L1 point of the secondary sheet and/or such that the primary fourth L2 point of the primary sheet is aligned with the secondary fourth L2 point of the secondary sheet. The primary sheet and the secondary sheet may be arranged such that the primary fourth L3 point of the primary sheet is aligned with the secondary fourth L3 point of the secondary sheet and/or such that the primary fourth L4 point of the primary sheet is aligned with the secondary fourth L4 point of the secondary sheet. The primary sheet and the secondary sheet may be arranged such that the primary fourth L5 point of the primary sheet is aligned with the secondary fourth L5 point of the secondary sheet and/or such that the primary fourth L6 point of the primary sheet is aligned with the secondary fourth L6 point of the secondary sheet.

The primary sheet and the secondary sheet may be arranged such that the primary fifth L1 point of the primary sheet is aligned with the secondary fifth L1 point of the secondary sheet and/or such that the primary fifth L2 point of the primary sheet is aligned with the secondary fifth L2 point of the secondary sheet. The primary sheet and the secondary sheet may be arranged such that the primary fifth L3 point of the primary sheet is aligned with the secondary fifth L3 point of the secondary sheet and/or such that the primary fifth L4 point of the primary sheet is aligned with the secondary fifth L4 point of the secondary sheet. The primary sheet and the secondary sheet may be arranged such that the primary fifth L5 point of the primary sheet is aligned with the secondary fifth L5 point of the secondary sheet and/or such that the primary fifth L6 point of the primary sheet is aligned with the secondary fifth L6 point of the secondary sheet.

The primary sheet and/or the secondary sheet may be a piece of light fabric or cloth of glass fibre, carbon fibre, cotton, linen, flax, hemp, synthetic filaments or any other similar material.

The part element may comprise one or more pre-shaped elements, e.g. Including a first pre-shaped element and/or a second pre-shaped element. The method may comprise providing a pre-shaped element, such as the first pre-shaped element and/or the second pre-shaped element. The pre-shaped element(s) may be pultruded element(s), such as pultruded strips, e.g. the first pre-shaped element may be a first pultruded element and/or a first pultruded strip and/or the second pre-shaped element may be a second pultruded element and/or a second pultruded strip. The pre-shaped element(s), such as the first pre-shaped element and/or the second pre-shaped element may be arranged, e.g. positioned, between the first fibre thread and the second fibre thread. The pre-shaped element(s) may comprise carbon material. For example, the pre-shaped element(s) may be pultruded carbon element(s).

The pre-shaped element(s) may be positioned on the primary sheet. The pre-shaped element(s) may be positioned between the primary sheet and the secondary sheet. The pre-shaped element(s) may be positioned between the first fibre thread and the second fibre thread. The pre-shaped element(s) may be positioned between the first primary loop and the second primary loop. Alternatively, or additionally, the pre-shaped element(s) may be positioned between the third fibre thread and the fourth fibre thread, e.g. between the third primary loop and the fourth primary loop. The pre-shaped element(s) may be positioned after providing the first fibre thread and/or the second fibre thread. The pre-shaped element(s) may be positioned after arranging the secondary sheet and the primary sheet and/or after providing the first primary loop to extend to the secondary first side of the secondary sheet and/or after providing the second primary loop to extend to the secondary first side of the secondary sheet. By providing the pre-shaped elements after providing the fibre threads, the pre-shaped element(s) may be positioned more precisely as provision of the fibre threads does not risk disturbing the positioning of the pre-shaped elements.

The second pre-shaped element may be aligned with the first pre-shaped element, e.g. the first pre-shaped element and the second pre-shaped element may extend in the longitudinal direction between the same points and/or the first pre-shaped element and the second pre-shaped element may extend in the transverse direction between the same points. For example, the second pre-shaped element may be arranged between the first fibre thread and the second fibre thread, e.g. between the first primary loop and the second primary loop. Alternatively, or additionally, the second pre-shaped element may be positioned between the third fibre thread and the fourth fibre thread, e.g. between the third primary loop and the fourth primary loop. The first pre-shaped element and the second pre-shaped element may be stacked, e.g. the second pre-shaped element may be arranged on top of the first pre-shaped element.

The first pre-shaped element and the second pre-shaped element may be arranged following each other in the longitudinal direction, e.g. the first pre-shaped element and the second pre-shaped element may be arranged after each other along the longitudinal direction. Alternatively, the first pre-shaped element and the second pre-shaped element may be arranged after each other along the transverse direction, e.g. the first pre-shaped element and the second pre-shaped element may be arranged next to each other in the transverse direction. The pre-shaped elements, such as the first pre-shaped element and the second pre-shaped elements may have different lengths, widths and/or thicknesses.

The secondary sheet may be arranged such that the first primary slit is aligned with the first primary loop and the second primary slit is aligned with the second primary loop, and such that the pre-shaped element is arranged between the primary sheet and the secondary sheet. The first primary loop may be pulled through the first primary slit in the secondary sheet. The second primary loop may be pulled through the second primary slit in the secondary sheet.

The advantage of the present disclosure is an easier way of laying up layers comprising pultruded members, as the part element may provide a more flexible and easier way of controlling the position of the pre-shaped elements. The part element is moreover able to retain pultruded members of different sizes, which may give the part element a property of high drapability and ability to adapt better to curved surfaces than current solutions.

Furthermore, the layers may be laid up outside the blade shell mould, reducing in-mould manufacturing time, thus reducing the total manufacturing time. The part element may provide a better way of transferring pre-shaped elements onto other layers of materials, such as glass fibres, reducing the occurrence of wrinkles which may cause weak spots in a wind turbine blade.

The part element may comprise a first fibre strip. The method may comprise providing the first fibre strip. The first fibre strip may be configured to extend through the first primary loop and/or the second primary loop. Alternatively or additionally, the first fibre strip may be configured to extend through the third primary loop, the fourth primary loop, the first secondary loop and/or the fifth primary loop. The first fibre strip be a wide fibre strip, such as a tape. Alternatively, the fibre strip may have a thread or rope like shape, such as a yarn, such as a cotton yarn, such as a string or a tow. The fibre strip may comprise materials such as glass fibre, carbon fibre, cotton, linen, flax, hemp, synthetic filaments or any other similar material.

The first fibre strip may be pulled through the first primary loop of the first fibre thread and the second primary loop of the second fibre thread. The strip may be fastened or tightened to retain the pre-shaped element(s).

The first fibre strip may engage with a plurality of loops. The first fibre strip may engage with loops, such that the first fibre strip extends in a direction perpendicular to the longitudinal direction of the pre-shaped elements. The first fibre strip may engage with loops, such that the first fibre strip extends in direction at an angle between 0-180° relative to the longitudinal direction of the pre-shaped element(s). The first fibre strip may engage with loops in a first column, e.g. the first primary loop, the second primary loop, the third primary loop, the fourth primary loop and/or the fifth primary loop, and turn to engage with loops in a second column, e.g. the first secondary loop, the second secondary loop, the third secondary loop, the fourth secondary loop and/or the fifth secondary loop.

The part element may comprise the secondary sheet without the fibre strip for retaining the pre-shaped elements. The part element may comprise the fibre strip without the secondary sheet for retaining the pre-shaped elements. The part element may comprise both the secondary sheet and the fibre strip for retaining the pre-shaped elements.

The part element may comprise a tertiary sheet. The method may comprise providing the tertiary sheet. The tertiary sheet may comprise fibres, e.g. the tertiary sheet may comprise fibres extending in a longitudinal direction and/or in a transverse direction. The tertiary sheet may have a tertiary first side and a tertiary second side.

The tertiary sheet and the secondary sheet may be arranged such that the secondary first side of the secondary sheet is facing the tertiary second side of the tertiary sheet. The first primary loop may be provided to extend to the tertiary first side of the tertiary sheet. The second primary loop may be provided to extend to the tertiary first side of the tertiary sheet.

The tertiary sheet may comprise one or more slits configured to receive fibre threads, e.g. a part of loops.

The tertiary sheet may comprise a first primary slit extending in a tertiary first direction from a tertiary first L1 point to a tertiary first L2 point. The first primary slit may be configured to receive part of the first fibre thread, e.g. the first primary loop or at least a part of the first primary loop. The first primary loop may extend through the first primary slit.

The tertiary sheet may comprise a first secondary slit extending in the tertiary first direction from a tertiary first L3 point to a tertiary first L4 point. The first secondary slit may be configured to receive part of the first fibre thread, e.g. the first secondary loop or at least a part of the first secondary loop. The first secondary loop may extend through the first secondary slit. The tertiary sheet may comprise a first tertiary slit extending in the tertiary first direction from a tertiary first L5 point to a tertiary first L5 point. The first tertiary slit may be configured to receive part of the first fibre thread, e.g. the first tertiary loop or at least a part of the first tertiary loop. The first tertiary loop may extend through the first tertiary slit.

The tertiary sheet may comprise a second primary slit. The second primary slit may extend in a tertiary second direction. The second primary slit may extend from a tertiary second L1 point to a tertiary second L2 point. The second primary slit may be configured to receive part of the second fibre thread, e.g. the second primary loop or at least a part of the second primary loop. The second primary loop may extend through the second primary slit. The tertiary sheet may comprise a second secondary slit extending in the tertiary second direction from a tertiary second L3 point to a tertiary second L4 point. The second secondary slit may be configured to receive part of the second fibre thread, e.g. the second secondary loop or at least a part of the second secondary loop. The second secondary loop may extend through the second secondary slit. The tertiary sheet may comprise a second tertiary slit extending in the tertiary second direction from a tertiary second L5 point to a tertiary second L6 point. The second tertiary slit may be configured to receive part of the second fibre thread, e.g. the second tertiary loop or at least a part of the second tertiary loop. The second tertiary loop may extend through the second tertiary slit. The tertiary first direction and the tertiary second direction may be substantially parallel. The first primary slit, the first secondary slit, the first tertiary slit, the second primary slit, the second secondary slit, and/or the second tertiary slit may extend substantially parallel.

The tertiary sheet may comprise a third primary slit. The third primary slit may extend in a tertiary third direction. The third primary slit may extend from a tertiary third T1 point to a tertiary third T2 point. The third slit may be configured to receive part of the third fibre thread, e.g. the second primary loop or at least a part of the third primary loop. The third primary loop may extend through the third primary slit. The tertiary sheet may comprise a third secondary slit extending in the tertiary third direction from a tertiary third T3 point to a tertiary third T4 point. The third secondary slit may be configured to receive part of the third fibre thread, e.g. the third secondary loop or at least a part of the third secondary loop. The third secondary loop may extend through the third secondary slit. The tertiary sheet may comprise a third tertiary slit extending in the tertiary third direction from a tertiary third T5 point to a tertiary third T6 point. The third tertiary slit may be configured to receive part of the third fibre thread, e.g. the third tertiary loop or at least a part of the third tertiary loop. The third tertiary loop may extend through the third tertiary slit. The tertiary first direction and the tertiary third direction may be substantially perpendicular. The tertiary second direction and the tertiary third direction may be substantially perpendicular. The third primary slit may extend in a direction different than the tertiary second direction and/or the tertiary first direction.

The tertiary sheet may comprise a fourth primary slit. The fourth primary slit may extend in a tertiary fourth direction. The fourth primary slit may extend from a tertiary fourth T1 point to a tertiary fourth T2 point. The fourth slit may be configured to receive part of the fourth fibre thread, e.g. the fourth primary loop or at least a part of the fourth primary loop. The fourth primary loop may extend through the fourth primary slit. The tertiary sheet may comprise a fourth secondary slit extending in the tertiary fourth direction from a tertiary fourth T3 point to a tertiary fourth T4 point. The fourth secondary slit may be configured to receive part of the fourth fibre thread, e.g. the fourth secondary loop or at least a part of the fourth secondary loop. The fourth secondary loop may extend through the fourth secondary slit. The tertiary sheet may comprise a fourth tertiary slit extending in the tertiary fourth direction from a tertiary fourth T5 point to a tertiary fourth T6 point. The fourth tertiary slit may be configured to receive part of the fourth fibre thread, e.g. the fourth tertiary loop or at least a part of the fourth tertiary loop. The fourth tertiary loop may extend through the fourth tertiary slit. The tertiary first direction and the tertiary fourth direction may be substantially perpendicular. The tertiary second direction and the tertiary fourth direction may be substantially perpendicular. The tertiary third direction and the tertiary fourth direction may be substantially parallel. The fourth primary slit may extend in a direction different than the tertiary second direction and/or the tertiary first direction, e.g. the tertiary fourth direction may be perpendicular to the tertiary second direction and/or the tertiary first direction. The fourth primary slit and the third primary slit may extend substantially parallel.

The tertiary sheet may comprise a fifth primary slit. The fifth primary slit may extend in a tertiary fifth direction. The fifth primary slit may extend from a tertiary fifth L1 point to a tertiary fifth L2 point. The fifth primary slit may be configured to receive part of the fifth fibre thread, e.g. the fifth primary loop or at least a part of the fifth primary loop. The fifth primary loop may extend through the fifth primary slit. The tertiary sheet may comprise a fifth secondary slit extending in the tertiary fifth direction from a tertiary fifth L3 point to a tertiary fifth L4 point. The fifth secondary slit may be configured to receive part of the fifth fibre thread, e.g. the fifth secondary loop or at least a part of the fifth secondary loop. The fifth secondary loop may extend through the fifth secondary sit. The tertiary sheet may comprise a fifth tertiary slit extending in the tertiary fifth direction from a tertiary fifth L5 point to a tertiary fifth L6 point. The fifth tertiary slit may be configured to receive part of the fifth fibre thread, e.g. the fifth tertiary loop or at least a part of the fifth tertiary loop. The fifth tertiary loop may extend through the fifth tertiary slit. The tertiary first direction and the tertiary fifth direction may be substantially parallel. The tertiary second direction and the tertiary fifth direction may be substantially parallel. The tertiary third direction and the tertiary fifth direction may be substantially perpendicular. The tertiary fourth direction and the tertiary fifth direction may be substantially perpendicular. The fifth primary slit and the first primary slit may extend substantially parallel.

The tertiary sheet may have a tertiary first side and a tertiary second side. The secondary first side of the secondary sheet may be arranged to face the tertiary sheet, e.g. such as to face the tertiary second side of the tertiary sheet.

The primary sheet and the tertiary sheet may be arranged such that the primary first L1 point of the primary sheet is aligned with the tertiary first L1 point of the tertiary sheet and/or such that the primary first L2 point of the primary sheet is aligned with the tertiary first L2 point of the tertiary sheet. The tertiary sheet may be arranged such that the slits in the secondary sheet are aligned with the slits in the tertiary sheet.

The primary sheet and the tertiary sheet may be arranged such that the primary first L1 point of the primary sheet is aligned with the tertiary first L1 point of the tertiary sheet and/or such that the primary first L2 point of the primary sheet is aligned with the tertiary first L2 point of the tertiary sheet. The primary sheet and the tertiary sheet may be arranged such that the primary first L3 point of the primary sheet is aligned with the tertiary first L3 point of the tertiary sheet and/or such that the primary first L4 point of the primary sheet is aligned with the tertiary first L4 point of the tertiary sheet. The primary sheet and the tertiary sheet may be arranged such that the primary first L5 point of the primary sheet is aligned with the tertiary first L5 point of the tertiary sheet and/or such that the primary first L6 point of the primary sheet is aligned with the tertiary first L6 point of the tertiary sheet.

The primary sheet and the tertiary sheet may be arranged such that the primary second L1 point of the primary sheet is aligned with the tertiary second L1 point of the tertiary sheet and/or such that the primary second L2 point of the primary sheet is aligned with the tertiary second L2 point of the tertiary sheet. The primary sheet and the tertiary sheet may be arranged such that the primary second L3 point of the primary sheet is aligned with the tertiary second L3 point of the tertiary sheet and/or such that the primary second L4 point of the primary sheet is aligned with the tertiary second L4 point of the tertiary sheet. The primary sheet and the tertiary sheet may be arranged such that the primary second L5 point of the primary sheet is aligned with the tertiary second L5 point of the tertiary sheet and/or such that the primary second L6 point of the primary sheet is aligned with the tertiary second L6 point of the tertiary sheet.

The primary sheet and the tertiary sheet may be arranged such that the primary third L1 point of the primary sheet is aligned with the tertiary third L1 point of the tertiary sheet and/or such that the primary third L2 point of the primary sheet is aligned with the tertiary third L2 point of the tertiary sheet. The primary sheet and the tertiary sheet may be arranged such that the primary third L3 point of the primary sheet is aligned with the tertiary third L3 point of the tertiary sheet and/or such that the primary third L4 point of the primary sheet is aligned with the tertiary third L4 point of the tertiary sheet. The primary sheet and the tertiary sheet may be arranged such that the primary third L5 point of the primary sheet is aligned with the tertiary third L5 point of the tertiary sheet and/or such that the primary third L6 point of the primary sheet is aligned with the tertiary third L6 point of the tertiary sheet.

The primary sheet and the tertiary sheet may be arranged such that the primary fourth L1 point of the primary sheet is aligned with the tertiary fourth L1 point of the tertiary sheet and/or such that the primary fourth L2 point of the primary sheet is aligned with the tertiary fourth L2 point of the tertiary sheet. The primary sheet and the tertiary sheet may be arranged such that the primary fourth L3 point of the primary sheet is aligned with the tertiary fourth L3 point of the tertiary sheet and/or such that the primary fourth L4 point of the primary sheet is aligned with the tertiary fourth L4 point of the tertiary sheet. The primary sheet and the tertiary sheet may be arranged such that the primary fourth L5 point of the primary sheet is aligned with the tertiary fourth L5 point of the tertiary sheet and/or such that the primary fourth L6 point of the primary sheet is aligned with the tertiary fourth L6 point of the tertiary sheet.

The primary sheet and the tertiary sheet may be arranged such that the primary fifth L1 point of the primary sheet is aligned with the tertiary fifth L1 point of the tertiary sheet and/or such that the primary fifth L2 point of the primary sheet is aligned with the tertiary fifth L2 point of the tertiary sheet. The primary sheet and the tertiary sheet may be arranged such that the primary fifth L3 point of the primary sheet is aligned with the tertiary fifth L3 point of the tertiary sheet and/or such that the primary fifth L4 point of the primary sheet is aligned with the tertiary fifth L4 point of the tertiary sheet. The primary sheet and the tertiary sheet may be arranged such that the primary fifth L5 point of the primary sheet is aligned with the tertiary fifth L5 point of the tertiary sheet and/or such that the primary fifth L6 point of the primary sheet is aligned with the tertiary fifth L6 point of the tertiary sheet.

The tertiary sheet may be a piece of light fabric or cloth of glass fibre, carbon fibre, cotton, linen, flax, hemp, synthetic filaments or any other similar material.

One or more pre-shaped element(s), such as the first pre-shaped element, the second pre-shaped element and/or a third pre-shaped element may be arranged between the secondary sheet and the tertiary sheet.

The part element and/or sub-part of the part element may be transferred from a first position to a second position. The sub-part of the part element may refer to the primary sheet, the first pre-shaped element, the secondary sheet, the tertiary sheet, and/or other elements of the part element previously defined. The first position may be a pre-form mould. The second position may be a mould for manufacturing a spar beam or a mould for manufacturing a blade shell part. Transferring the part element and/or the sub-part may comprise attaching a transportation structure to the first fibre thread and/or the second fibre thread, e.g. attaching the transportation structure to the first primary loop and/or the second primary loop, e.g. by attaching the first primary loop and/or the second primary loop to hooks of the transportation structure.

Transferring the part element and/or the sub-part may comprise arranging the part element and/or the sub-part in a mould comprising an inclined surface. Arranging the part element and/or the sub-part may comprise aligning the part element on the inclined surface of the mould. Alternatively, the part element and/or the sub part may be arranged on a blade shell part in a blade shell mould.

The part element and/or the sub part may be Impregnated or infused with a resin. The method may comprise curing the part element and/or sub part, e.g. curing the resin thereof. The part element may be cured by infusing the part element with a resin. Infusion may be provided by vacuum assisted resin transfer moulding (VARTM). The part element and/or the sub part may be cured to provide a pre-form element before transferring the part element or sub part, e.g. the part element and/or sub part may be cured in the first position. Alternatively, the part element and/or sub part may be cured after transferring to a mould or a blade shell part, e.g. the part element and/or sub part may be cured in the second position. The part element and/or sub part may be cured in an inclined position, e.g. having an inclination between 0-90. The part element and/or sub part may be cured in a substantially horizontal position.

The primary sheet and/or the secondary sheet and/or the tertiary sheet may improve the infusion process by providing distribution paths for the resin. Thereby facilitating a more even distribution of the resin.

Also disclosed is a wind turbine blade comprising a part element, such as the above described part element, connecting a first blade section and a second blade section.

The first blade section may extend along a longitudinal axis from a root to a first end. The second blade section may extend along the longitudinal axis from a second end to a tip. The first blade section may comprise a root region and a first airfoil region. The second blade section may comprise a second airfoil region with the tip.

The part element may form a spar beam connecting the first blade section and the second blade section. The spar beam may longitudinally extend along a spar beam axis from a first beam position to a second beam position and may be positioned such that the first beam position is located in the first airfoil region and the second beam position is located in the second airfoil region. A third beam position, between the first beam position and the second beam position, may be aligned with the second end of the second blade section.

Alternatively, the part element may be used to hold dry fabric in place. The dry fabric may be arranged on the primary sheet and the dry fabric may comprise slits at corresponding locations to the loops of the primary sheet. The dry fabric may be arranged between a primary sheet and a secondary sheet. A fibre strip may be engaged with the loops of the primary sheet.

The part element may form a part of a wind turbine blade, such as a spar cap, a spar beam, a blade shell part, a shear web, a spar box. The part element may form part of a part of a wind turbine blade, such as a part of a spar cap, a spar beam, a blade shell part, a shear web, a spar box.

It is envisaged that any embodiments or elements as described in connection with any one aspect may be used with any other aspects or embodiments, mutatis mutandis.

### BRIEF DESCRIPTION OF THE FIGURES

Embodiments of the invention will be described in more detail in the following with regard to the accompanying figures. Uke reference numerals refer to like elements throughout. Uke elements may, thus, not be described in detail with respect to the description of each figure. The figures show one way of implementing the present invention and are not to be construed as being limiting to other possible embodiments falling within the scope of the attached claim set. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

FIG. 1 is a schematic diagram illustrating an exemplary wind turbine,

FIG. 2 is a schematic diagram illustrating an exemplary wind turbine blade,

FIG. 3 is a schematic diagram illustrating an exemplary wind turbine blade,

FIG. 4 is a schematic diagram illustrating an exemplary wind turbine blade,

FIG. 5a-5c are schematic diagrams illustrating an exemplary part of a wind turbine blade,

FIG. 6a-6c are schematic diagrams illustrating an exemplary part element,

FIG. 7 is schematic diagram illustrating an exemplary part element,

FIG. 8 is schematic diagram illustrating an exemplary part element,

FIG. 9a-9c are schematic diagrams illustrating an exemplary part element,

FIG. 10 is schematic diagram illustrating an exemplary part element,

FIG. 11 is schematic diagram illustrating an exemplary part element,

FIG. 12 is schematic diagram illustrating an exemplary part element,

FIG. 13 is schematic diagram illustrating an exemplary part element,

FIG. 14a-14d are schematic diagrams illustrating an exemplary part element, and

FIG. 15 is a block diagram of an exemplary method.

### DETAILED DESCRIPTION

In the following figure description, the same reference numbers refer to the same elements and may thus not be described in relation to all figures.

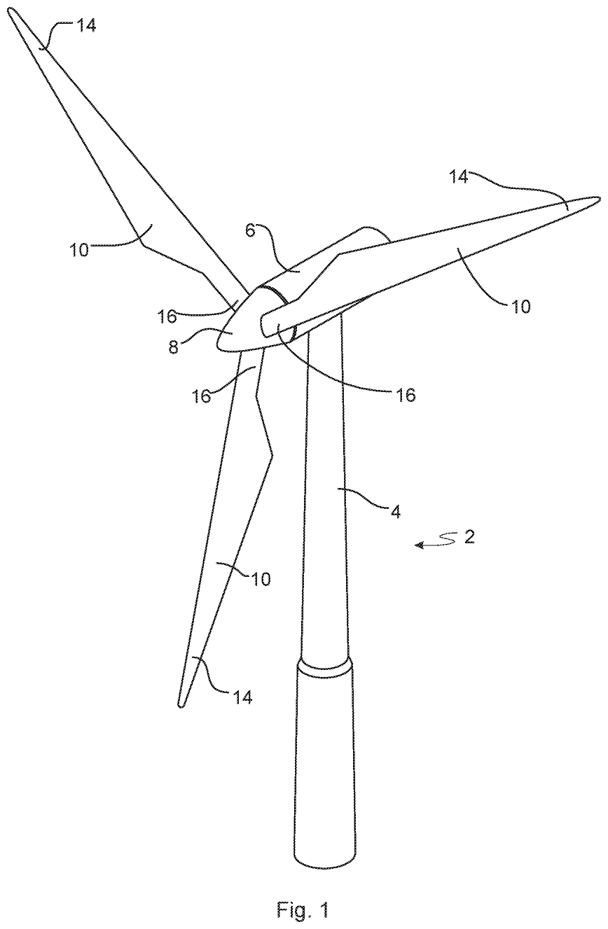

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 furthest from the hub 8.

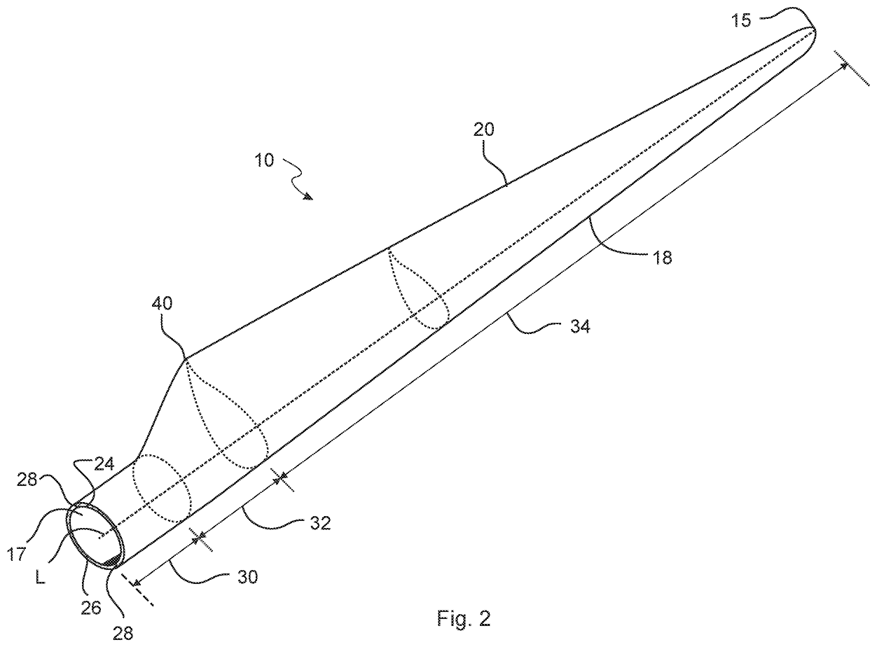

FIG. 2 shows a schematic view of an exemplary wind turbine blade 10. The wind turbine blade 10 has the shape of a conventional wind turbine blade with a root end 17 and a tip end 15 and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The wind turbine blade 10 comprises a blade shell comprising two blade shell parts or half shells, a first blade shell part 24 and a second blade shell part 26, typically made of fibre-reinforced polymer. The wind turbine blade 10 may comprise additional shell parts, such as a third shell part and/or a fourth shell part. The first blade shell part 24 is typically a pressure side or upwind blade shell part. The second blade shell part 26 is typically a suction side or downwind blade shell part. The first blade shell part 24 and the second blade shell part 26 are fastened together with adhesive, such as glue, along bond lines or glue joints 28 extending along the trailing edge 20 and the leading edge 18 of the blade 10. Typically, the root ends of the blade shell parts 24, 26 has a semi-circular or semi-oval outer cross-sectional shape.

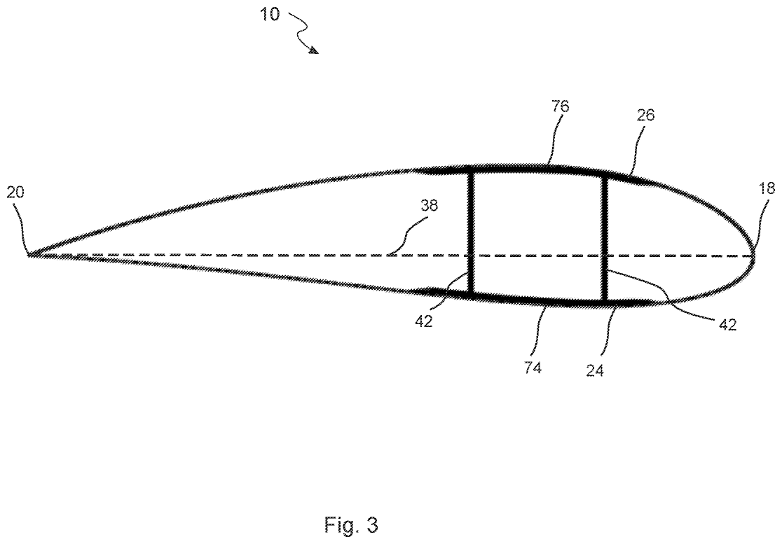

FIG. 3 is a schematic diagram illustrating a cross sectional view of an exemplary wind turbine blade 10, e.g. a cross sectional view of the airfoil region of the wind turbine blade 10. The wind turbine blade 10 comprises a leading edge 18, a trailing edge 20, a pressure side 24, a suction side 26 a first spar cap 74, and a second spar cap 76. The wind turbine blade 10 comprises a chord line 38 between the leading edge 18 and the trailing edge 20. The wind turbine blade 10 comprises shear webs 42, such as a leading edge shear web and a trailing edge shear web. The shear webs 42 could alternatively be a spar box with spar sides, such as a trailing edge spar side and a leading edge spar side. The spar caps 74, 76 may comprise carbon fibres while the rest of the shell parts 24, 26 may comprise glass fibres.

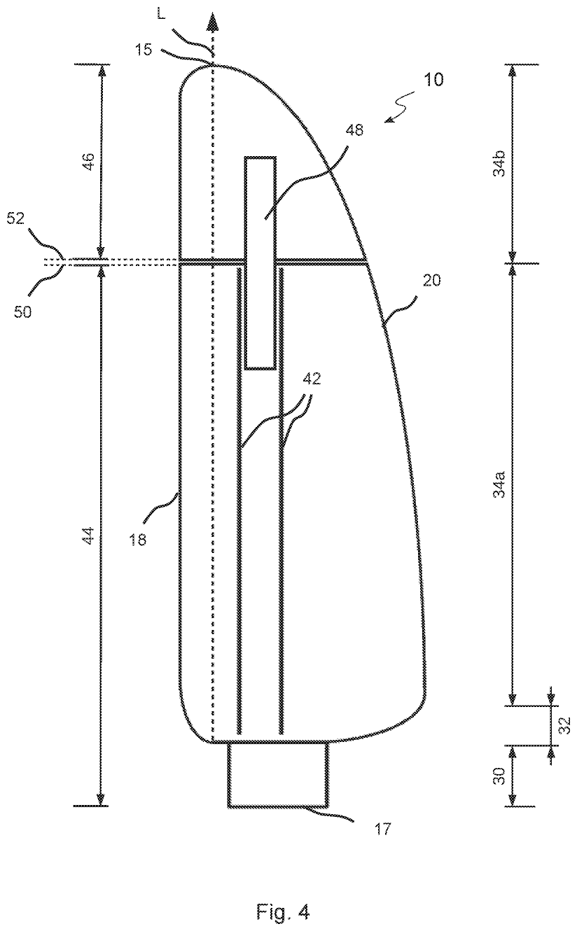

FIG. 4 is a schematic diagram illustrating an exemplary wind turbine blade 10, such as the wind turbine blade 10 of the previous figures. The wind turbine blade 10 comprises a leading edge 18, a trailing edge 20, a tip end 15 and a root end 17. The wind turbine blade 10 comprises shear webs 42, such as a leading edge shear web and a trailing edge shear web.

The wind turbine blade 10 is a so-called split blade, or two-part blade, or segmented blade. The wind turbine blade 10 comprises a first blade section 44 and a second blade section 46. The first blade section 44 extends along the longitudinal axis L from a root, such as the root end 17, to a first end 50. The second blade section 46 extends along the longitudinal axis L from a second end 52 to a tip, such as the tip end 15. The first blade section 44 comprises a root region 30, a first airfoil region 34a and a transition region 32 between the root region 30 and the first airfoil region 34a. The second blade section 46 comprises a second airfoil region 34b with the tip, such as the tip end 15. The first blade section 44 and the second blade section 46 may be connected with a spar beam 48.

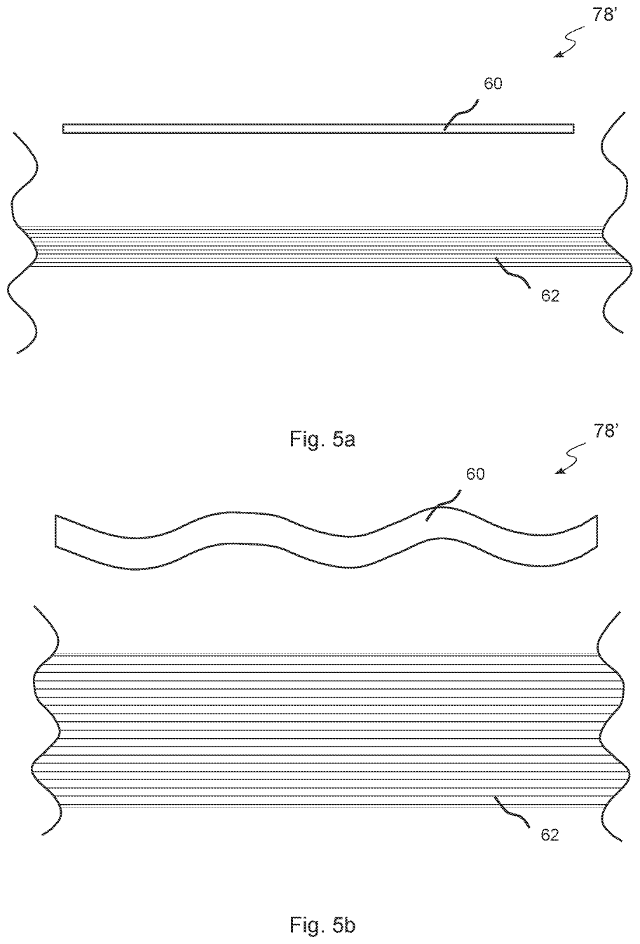

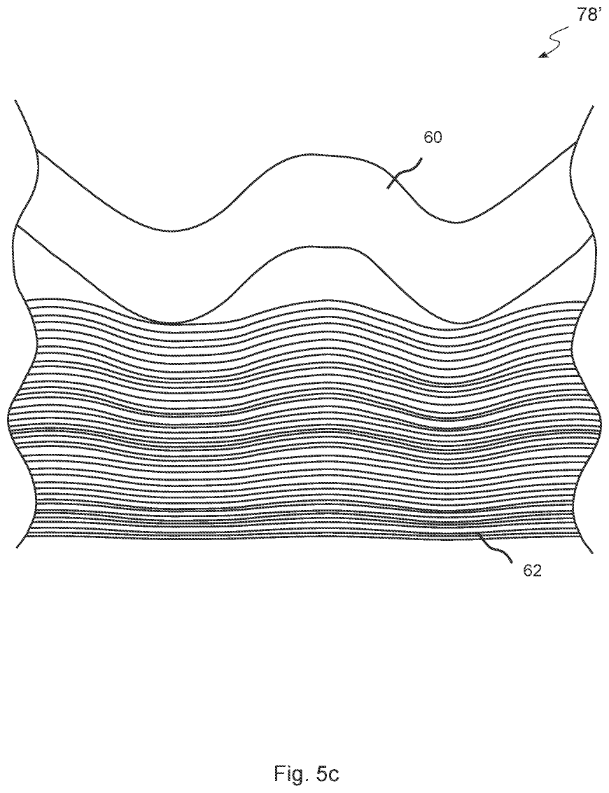

FIG. 5a is a schematic diagram illustrating an exemplary part element 78′ of a wind turbine blade, such as a reinforced part of a blade shell part, such as the spar cap 74, 76 of FIG. 3. The part element 78′ may comprise a pultruded member 60, such pultruded strips such as pultrusion members of carbon, which is arranged on top of a biax element 62, such as glass fibres. During assembly, the pultruded member 60 may be transferred and laid upon the biax element 62 and the parts may be infused with resin. The pultruded member 60 may be 60 m long and transferring the pultruded member 60 may be challenging, as the long pultruded member 60 often bends, as illustrated in FIG. 5b, which is an enlarged view of FIG. 5a.

FIG. 5c is a schematic enlargement of the pultruded member 60 and the biax element 62, illustrating the potential situation when the pultruded member 60 is lowered and laid upon the biax element 62. Because the pultruded member 60 becomes slightly bent during transferal, the biax element 62 will compress underneath the parts of the pultruded member 60 corresponding to valleys. The compression of the biax element 62 may cause wrinkles and weaknesses in the biax element 62, which in turn may cause weaknesses in the part element 78 and/or a wind turbine blade comprising the part element 78′.

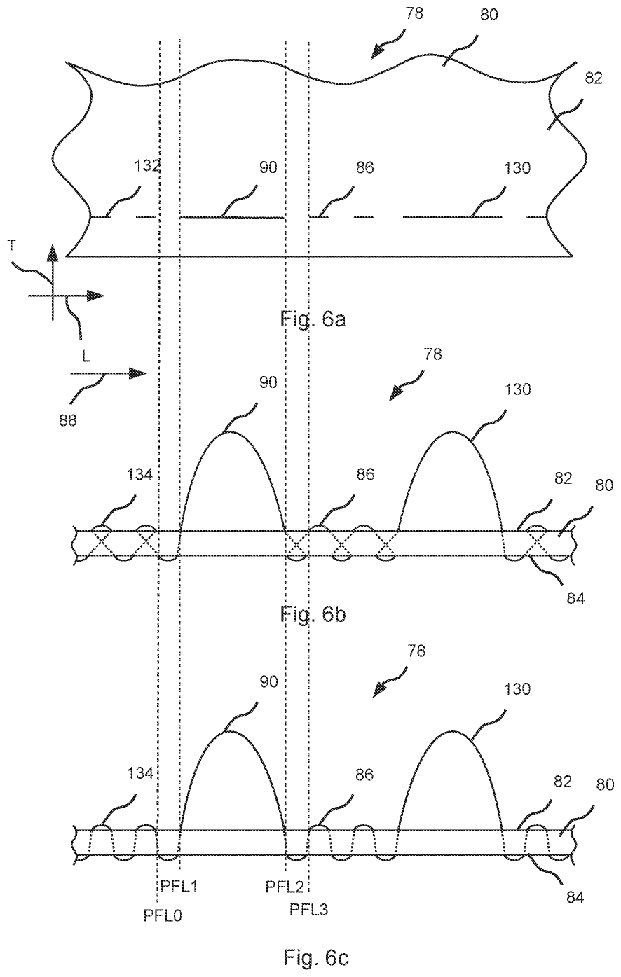

FIG. 6a-6c are schematic diagrams illustrating an exemplary part element 78. The part element 78 may mitigate some of the problems associated with the part element 78′ of FIG. 5a-c. The part element 78 comprises a primary sheet 80, such as a light fabric, such as glass fibre, and a fibre thread 86, such as a first fibre thread. The primary sheet 80 comprises fibres extending in the longitudinal L and the transverse T direction and has a primary first side 82 and a primary second side 84. The fibre thread 86 is sewn into the primary sheet 80 forming stitches 134 and loops 90, 130. When the fibre thread is sewn through the sheet and back out, a stitch is created.

The part element 78 in FIG. 6a is seen from the primary first side 82 of the primary sheet 80 and the part element 78 in FIG. 6b-6c is seen in a cross-sectional view. The fibre thread 86 extends in a first direction 88. The fibre thread 86 forms a primary loop 90 from a primary first L1 point PFL1 to a primary first L2 point PFL2 on the primary first side 82 of the primary sheet 80. The fibre thread 86 extends from a primary first L1 point PFL1 to a primary first L0 point PFL0 on the primary second side 84 of the primary sheet 80. The fibre thread 86 extends from a primary first L2 point PFL2 to a primary first L3 point PFL3 on the primary second side 84 of the primary sheet 80.

FIG. 6b Illustrates stitches 134 being backstitches, e.g. stitches where the fibre thread 86 crosses itself, thereby anchoring the fibre thread 86 at the backstitch 134 to the primary sheet 80. The fibre thread 86 may cross itself next to a loop or the fibre thread 86 may cross itself at a distance from the loop, e.g. extending on the primary second side 84 between the loop and the backstitch 134. FIG. 6c Illustrates stitches 134 being running stitches, e.g. stitches where the fibre thread 86 does not cross itself. With running stitches 134 the fibre thread 86 may be pulled at free ends, e.g. to tighten the fibre thread 86. The figures are examples of stitches, but any combination of the described stitches, or any other type of stitches, is possible. By placing backstitches after loops the size of the loop may be fixed.

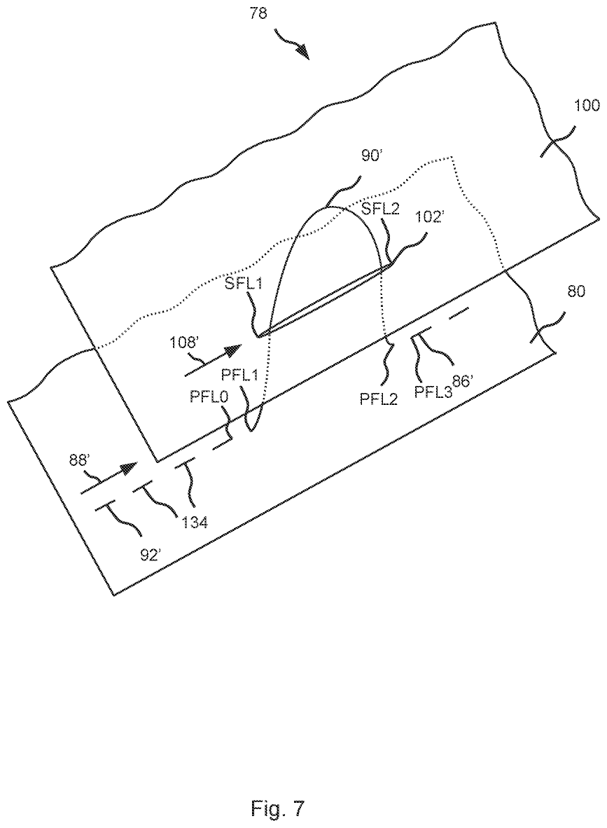

FIG. 7 is a schematic diagram illustrating an exemplary part element 78, such as the part element of FIGS. 6a-c. The part element 78 comprises a primary sheet 80 and a first fibre thread 86′ extending in a primary first direction 88′. The first end 92′ of the first fibre thread 86′ is anchored to the primary sheet 80, e.g. with a backstitch (see FIG. 6b). The first fibre thread 86′ forms stitches 134 and forms a first primary loop 90′ from a primary first L1 point PFL1 to a primary first L2 point PFL2. The part element 78 comprises a secondary sheet 100. The secondary sheet 100 comprises a first primary slit 102′ extending in a secondary first direction 108′ from a secondary first L1 point SFL1 to a secondary first L2 point SFL2. In FIG. 7 the first primary loop 90′ engages with the first primary slit 102′ by extending through the first primary slit 102′. The primary first L1 point PFL1 is aligned with the secondary first L1 point SFL1 and the primary first L2 point PFL2 is aligned with the secondary first L2 point SFL2.

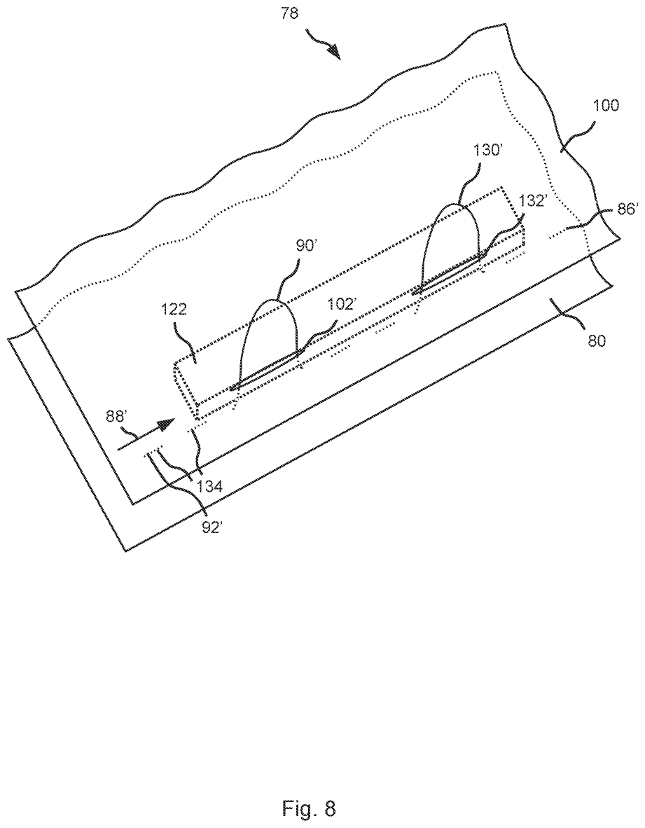

FIG. 8 is a schematic diagram illustrating an exemplary part element 78, such as the part element of FIGS. 6-7. The part element 78 comprises a primary sheet 80 and a first fibre thread 86 extending in a primary first direction 88′. The first end 92′ of the first fibre thread 86′ is anchored to the primary sheet 80, e.g. with a backstitch (see FIG. 6b). The first fibre thread 86′ forms stitches 134, a first primary loop 90′ and a first secondary loop 130′. The part element 78 comprises a secondary sheet 100. The secondary sheet 100 comprises a first primary slit 102′ and a first secondary slit 132′. In FIG. 8 the first primary loop 90′ engages with the first primary slit 102′ by extending through the first primary slit 102′ and the first secondary loop 90″ engages with the first secondary silt 102″ by extending through the slit 102″. A pre-shaped element 122 is arranged between the primary sheet 80 and the secondary sheet 100. The pre-shaped element 122 is aligned with the first primary loop 90′ and the first secondary loop 130′. The part element 78 illustrated in FIG. 8 may comprise more fibre threads, loops, stitches, slits and pre-shaped elements than illustrated in FIG. 8.

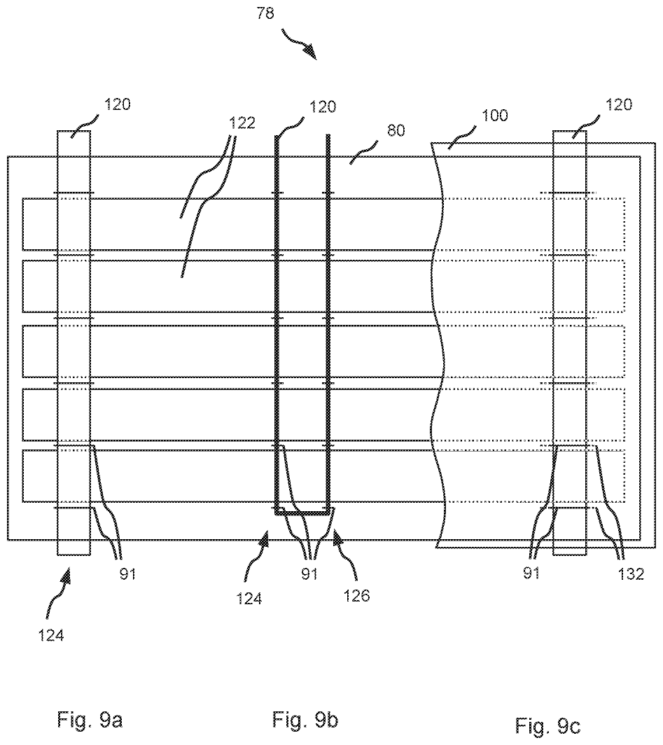

FIG. 9a-9c are schematic diagrams illustrating exemplary part elements 78, such as the part element of the previous FIGS. 6-8. FIG. 9a-9c Illustrates different solutions to retaining the pre-shaped elements. Two or more of the solutions may be combined or one of the solutions may be used.

FIG. 9a shows a part element 78 comprising a primary sheet 80 and loops 91. Pre-shaped elements 122 are arranged between the loops 91 and a fibre strip 120 extends in a direction perpendicular to the direction of the loops 91. The fibre strip 120 engages with the loops 91 to retain the pre-shaped elements 122. The fibre strip may be wide, such as in FIG. 9a, or the fibre strip may be narrow such as in FIG. 9b. The size of the loops 91 may be adjusted in accordance with the width of the fibre strip 120. The fibre strip 120 may engage with loops of a first column 124, as in FIG. 9a, and/or the fibre strip 120 may engage with loops of a plurality of columns, e.g. a first column 124 and a second column 126, such as illustrated in FIG. 9b.

FIG. 9c shows the part element 78 comprising a primary sheet 80 and a secondary sheet 100. The secondary sheet 100 comprises sifts 132 engaging with loops 91. Pre-shaped elements 122 are arranged between the primary sheet 80 and the secondary sheet 100 and aligned between the loops 91. A fibre strip 120 extends in a direction perpendicular to the direction of the loops 91. The fibre strip 120 is engaging with the loops 91.

For illustrative purposes, the part element 78 illustrated in the following figures are configured according to the solution in FIG. 9c, however any of the solutions illustrated in 9a-9c may be applied.

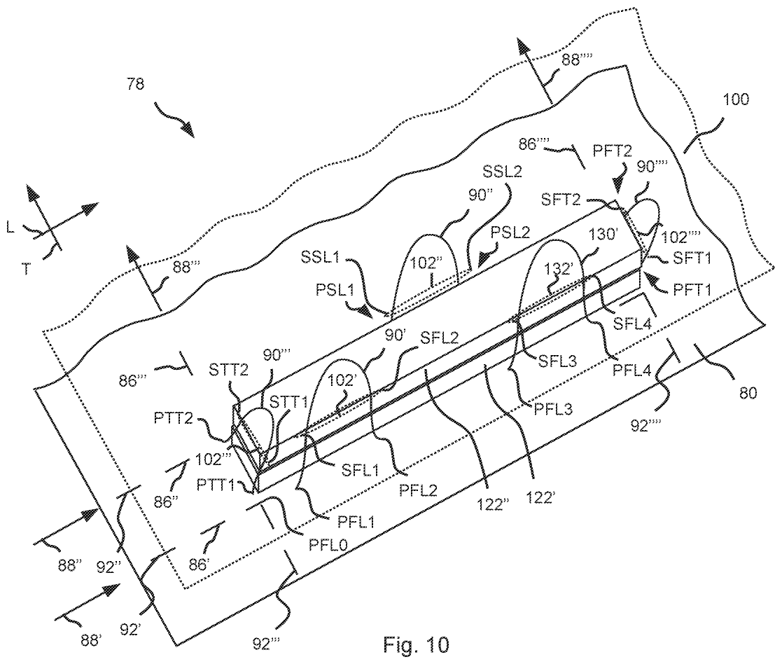

FIG. 10 is a schematic diagram illustrating an exemplary part element 78, such as the part element of FIGS. 6-9. The part element 78 comprises a primary sheet 80 and a first fibre thread 86′ extending in a primary first direction 88′. The first end 92′ of the first fibre thread 86′ is anchored to the primary sheet 80, e.g. with a backstitch (see FIG. 6b). The first fibre thread 86′ forms a first primary loop 90′, between the primary first L1 point PFL1 and the primary first L2 point PFL2, and a first secondary loop 130′ between the primary first L3 point PFL3 and the primary first L4 point PFL4. A second fibre thread 86″ extends in a primary second direction 88″ and the first end 92″ of the second fibre thread 86″ is anchored to the primary sheet 80, e.g. with a backstitch (see FIG. 6b). The second fibre thread 86″ forms a second primary loop 90″ between the primary second L1 point PSL1 and the primary second L2 point PSL2. The primary first direction 88′ and the primary second direction 88″ are substantially parallel. The primary first direction 88′ and/or the primary second direction 88″ and the longitudinal direction of the primary sheet L may be parallel. Alternatively, the primary first direction 88′ and/or the primary second direction 88″ and the transverse direction T of the primary sheet may be parallel, or the primary first direction 88′ and/or the primary second direction 88″ may be angled between the longitudinal direction L or the transverse direction T.

A third fibre thread 86′″ extends in a primary third direction 88′″ and the first end 92′″ of the third fibre thread 86′″ is anchored to the primary sheet 80, e.g. with a backstitch (see FIG. 6b). The third fibre thread 86′″ forms a third primary loop 90′″ between the primary third T1 point PTT1 and the primary third T2 point PTT2. A fourth fibre thread 86″″ extends in a primary fourth direction 88″″ and the first end 92″″ of the fourth fibre thread 86″″ is anchored to the primary sheet 80, e.g. with a backstitch (see FIG. 6b). The fourth fibre thread 86″″ forms a fourth primary loop 90″″ between the primary fourth T1 point PFT1 and the primary fourth T2 point PFT2. The primary third direction 88′″ and/or the primary fourth direction 88′″ and the transverse direction of the primary sheet T may be parallel. Alternatively, the primary third direction 88′″ and/or the primary fourth direction 88″″ and the longitudinal direction L of the primary sheet may be parallel, or the primary third direction 88′″ and/or the primary fourth direction 88″″ may be angled between the longitudinal direction L or the transverse direction T.

The part element 78 comprises a secondary sheet 100. The secondary sheet 100 comprises a first primary slit 102′ extending between a secondary first L1 point SFL1 and a secondary first L2 point SFL2, a first secondary slit 132′ between a secondary first L3 point SFL3 and a secondary first L4 point SFL4, a second primary slit 102″ between a secondary second L1 point SSL1 and a secondary second L2 point SSL2, a third primary slit 102′″ between a secondary third T1 point STT1 and a secondary third T2 point STT2, and a fourth primary slit 102″″ between a secondary fourth T1 point SFT1 and a secondary fourth T2 point SFT2. The first primary loop 90′ engages with the first primary slit 102′ by extending through the first primary slit 102′, the first secondary loop 130′ engages with the first secondary slit 132′ by extending through the first secondary slit 132′, the second primary loop 90″ engages with the second primary slit 102″ by extending through the second primary slit 102″, the third primary loop 90′″ engages with the third primary slit 102′″ by extending through the third primary slit 102′″, the fourth primary loop 90″″ engages with the fourth primary slit 102″″ by extending through the fourth primary slit 102″″.

A first pre-shaped element 122′ is arranged between the primary sheet 80 and the secondary sheet 100. The first pre-shaped element 122′ is arranged between the first primary loop 90′, the first secondary loop 130′, the second primary loop 90″, the third primary loop 90′″ and the fourth primary loop 90″″. The first pre-shaped element 122′ extends in a direction substantially parallel to the primary first direction 88′ and/or the primary second direction 88″. The first pre-shaped element 122′ extends in a transverse direction between the first fibre thread 86′ and the second fibre thread 86″. The first pre-shaped element 122′ extends in a longitudinal direction between the third fibre thread 86′″ and the fourth fibre thread 86″″.

A second pre-shaped element 122″ is aligned with the first pre-shaped element 122′. The second pre-shaped element 122″ is arranged between the primary sheet 80 and the secondary sheet 100. The second pre-shaped element 122″ is arranged between the first primary loop 90′, the first secondary loop 130′, the second primary loop 90″, the third primary loop 90′″ and the fourth primary loop 90″″. The second pre-shaped element 122″ extends in a direction substantially parallel to the primary first direction 88′ and/or the primary second direction 88″. The second pre-shaped element 122″ extends in a transverse direction between the first fibre thread 86′ and the second fibre thread 86″. The second pre-shaped element 122″ extends in a longitudinal direction between the third fibre thread 86′″ and the fourth fibre thread 86″″.

The part element 78 illustrated in FIG. 10 may comprise more fibre threads, loops, stitches, slits and/or pre-shaped elements than illustrated in FIG. 10.

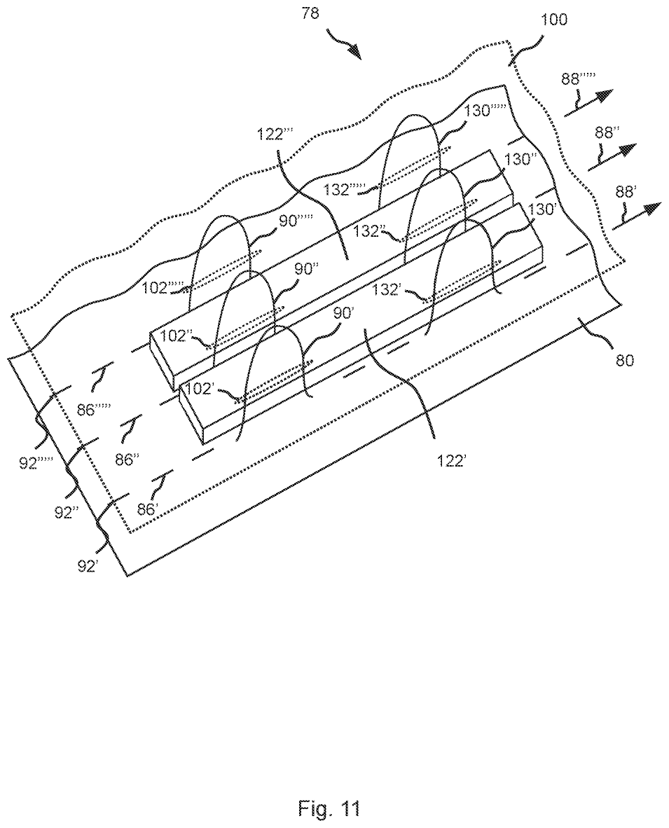

FIG. 11 is a schematic diagram illustrating an exemplary part element 78, such as the part element of FIGS. 6-10. The part element 78 comprises a primary sheet 80 and a first fibre thread 86′ extending in a primary first direction 88′. The first end 92′ of the first fibre thread 86′ is anchored to the primary sheet 80, e.g. with a backstitch (see FIG. 6b). The first fibre thread 86′ forms a first primary loop 90′ and a first secondary loop 130′. A second fibre thread 86″ extends in a primary second direction 88″ and the first end 92″ of the second fibre thread 86″ is anchored to the primary sheet 80, e.g. with a backstitch (see FIG. 6b). The second fibre thread 86″ forms a second primary loop 90″ and a second secondary loop 130″. The primary first direction 88′ and the primary second direction 88″ are substantially parallel. A fifth fibre thread 86′″″ extends in a primary fifth direction 88′″″ and the first end 92′″″ of the fifth fibre thread 86′″″ is anchored to the primary sheet 80, e.g. with a backstitch (see FIG. 6b). The fifth fibre thread 86′″″ forms a fifth primary loop 90′″″ and a fifth secondary loop 130′″″. The primary first direction 88′ and the primary fifth direction 88′″″ are substantially parallel.

The part element 78 comprises a secondary sheet 100. The secondary sheet 100 comprises a first primary slit 102′, a first secondary slit 132′, a second primary slit 102″, a second secondary slit 132″, a fifth primary slit 102′″″ and a fifth secondary slit 132′″″. The loops engage with the corresponding slits by extending through the slits.

A first pre-shaped element 122′ is arranged between the primary sheet 80 and the secondary sheet 100. The first pre-shaped element 122′ is arranged between the first fibre thread 86′ and the second fibre thread 86″. The first pre-shaped element 122′ extends in a direction substantially parallel to the primary first direction 88′ and/or the primary second direction 88″. The first pre-shaped element 122′ extends in a transverse direction between the first fibre thread 86′ and the second fibre thread 86″.

A third pre-shaped element 122′″ is aligned with the first pre-shaped element 122′. The third pre-shaped element 122′″ is arranged between the primary sheet 80 and the secondary sheet 100. The third pre-shaped element 122′″ is arranged between the second fibre thread 86″ and the fifth fibre thread 86′″″. The third pre-shaped element 122′″ extends in a direction substantially parallel to the primary first direction 88′ and/or the primary second direction 88″ and/or the primary fifth direction 88′″″. The third pre-shaped element 122′″ extends in a transverse direction between the second fibre thread 86″ and the fifth fibre thread 86′″″.

The part element 78 illustrated in FIG. 11 may comprise more fibre threads, loops, stitches, slits and/or pre-shaped elements than illustrated in FIG. 11.

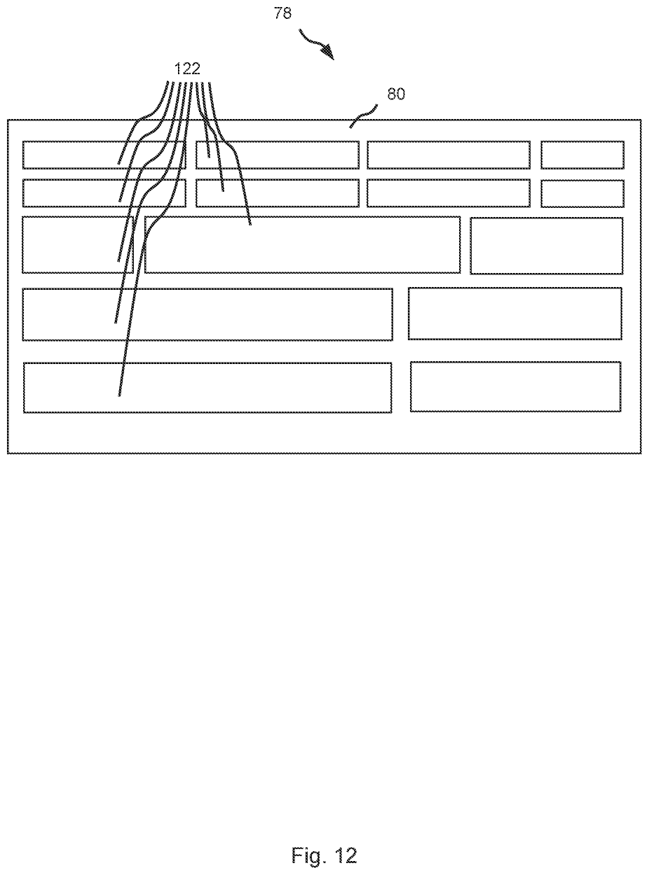

FIG. 12 is a schematic diagram illustrating an exemplary part element 78, such as the part element of FIGS. 6-11. The part element 78 comprises a plurality of pre-shaped elements arranged on a primary sheet 80. The part element 78 has an increased flexibility, because the pre-shaped elements 122 may be arranged differently for different areas of the part element 78, e.g. depending on the purpose of specific areas. The part elements 78 may have different lengths and/or widths. For illustrative purposes loops are not illustrated, but loops, as described with respect to previous figures, may be present between the pre-shaped elements 122. The pattern of the pre-shaped elements 78 may also improve the drapability of the part element 78.

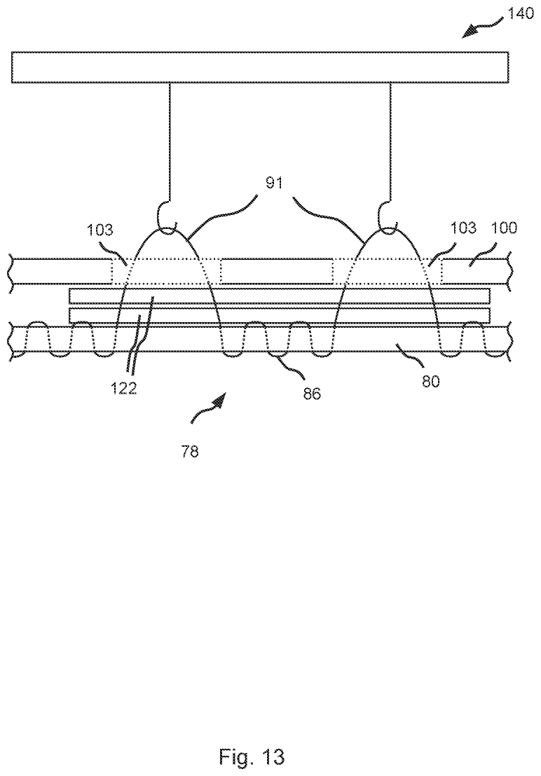

FIG. 13 is a schematic diagram illustrating an exemplary part element 78, such as the part element of FIGS. 6-12. The part element 78 comprises a primary sheet 80 and a secondary sheet 100.

The primary sheet 80 comprises a fibre thread 86 forming loops 91. The secondary sheet 100 comprises slits 103. The loops 91 are engaging with the slits 103. Pre-shaped elements 122 are arranged between the primary sheet 80 and the secondary sheet 100. The part element 78 may be transferred, e.g. after assembly of the part element 78, by connecting the loops 91 to a transportation structure. The loops 91, which may be evenly distributed along the longitudinal direction of the pre-shaped elements support the pre-shaped elements 122 so that bending of the pre-shaped element 122 (e.g. as explained with respect to FIG. 5) may be reduced. The transportation structure 140 may be a bar with hooks.

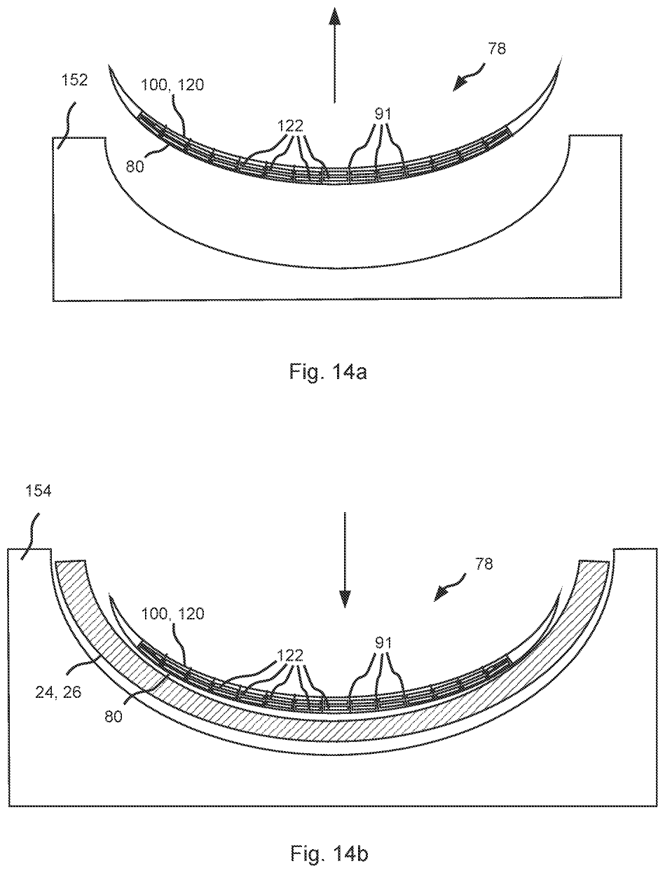

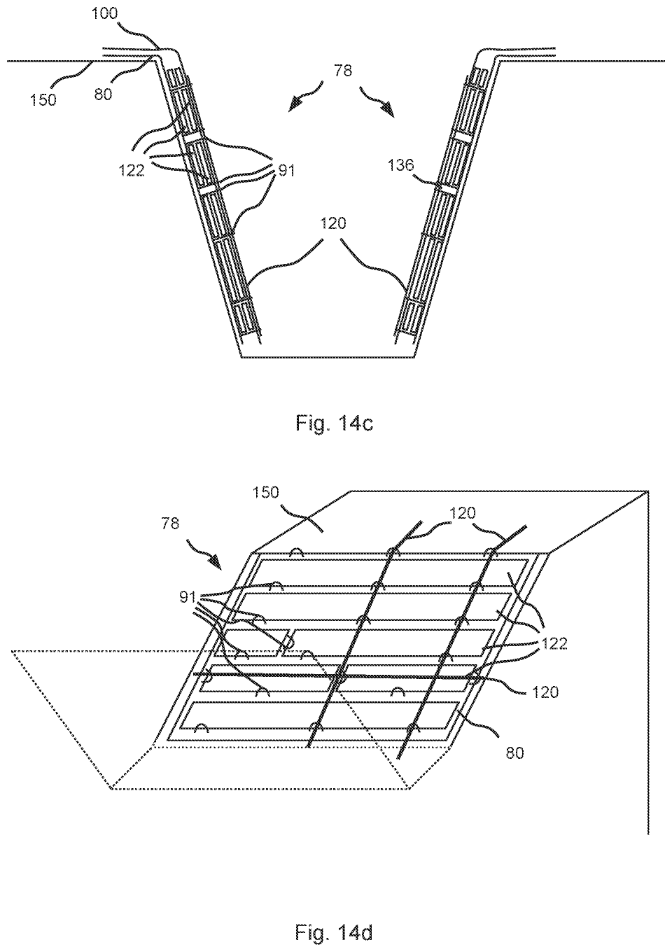

FIG. 14a-14d are schematic diagrams illustrating exemplary part elements 78, such as the part element FIGS. 6-13.

The part element 78 may be transferred from a first position, such as a pre-form mould 152, as illustrated in FIG. 14a, to a second position, such as on a shell part, such as the first blade shell part and/or the second blade shell part 24, 26 in a blade shell mould 154 as illustrated in FIG. 14b.

FIG. 14a schematically illustrates a pre-form mould 152 wherein the part element 78 may be manufactured. The part element 78 may be assembled by providing a primary sheet 80 and positioning the primary sheet 80 in the pre-form mould 152. Pre-shaped elements 122 may be provided and positioned on the primary sheet 80. A secondary sheet 100 and/or fibre strips 120 may be provided to retain the pre-shaped elements 122 by engaging with the loops 91 of the primary sheet 80. The part element 78 may be lifted from the pre-form mould 152 and transferred to a blade shell mould 154 with a transportation structure, such as the transportation structure 140 of FIG. 13.

FIG. 14b shows a blade shell mould 154 with a part element 78. The part element 78 is laid on top of a blade shell part, such as a first blade shell part 24 or a second blade shell part 26. The part element 78 may form a spar cap, such as the spar cap 74, 76 of FIG. 3. The part element 78 may have a high drapability and may be able to adapt to curved surfaces, such as an internal surface of a blade shell part 24, 26. The part element 78 may be cured hereafter, e.g. by vacuum assisted resin transfer moulding (VARTM).

Alternatively, as schematically illustrated in FIG. 14c, the second position may be a mould 150 for manufacturing a spar beam. The part element 78 may be transferred, e.g. as shown in FIG. 13, and placed into the mould 150. Retaining the pre-shaped elements 122 with the loops 91 allows the part element 78 to be tilted towards an upright position while the pre-shaped elements 122 is maintained in their intended positions before and while the part element is cured. Due to the high drapability of the part element 78 and the retained pre-shaped elements 122, the part element 78 may follow the contour of the mould 150 with an inclination. For example, the mould side may incline at an angle between 0-90°. The fibre strip 120 illustrated in FIGS. 14a-14d may be any of the strips 120 illustrated in the previous figures. Alternatively, the fibre strip 120 may represent a sheet, such as a secondary sheet. When the part element 78 has been transferred to the mould 150 the part element 78 may be cured, e.g. by vacuum assisted resin transfer moulding (VARTM).

FIG. 14d shows a perspective view of the mould 150, as also illustrated in FIG. 14c, with a part element 78. The mould 150 in FIG. 14c-14d may be a mould for manufacturing a spar beam, such as the spar beam 48 in FIG. 4. However, moulds for manufacturing other parts of a wind turbine blade may also be used.

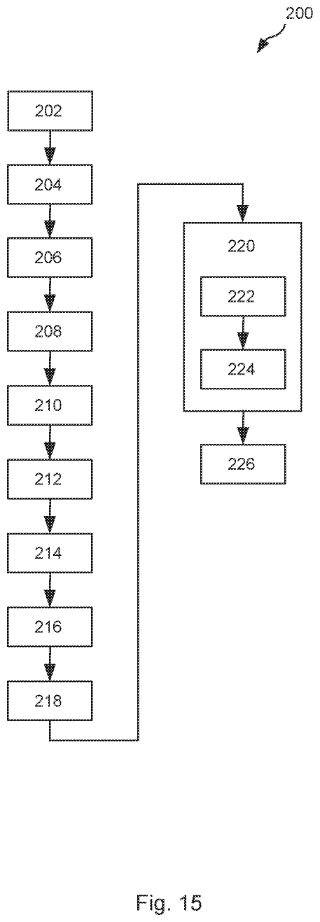

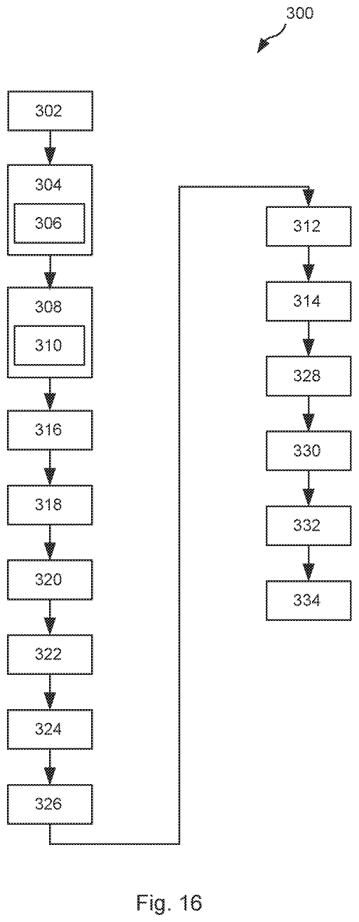

FIG. 15 is a block diagram of an exemplary method 200 for manufacturing a part element for a wind turbine blade, such as the part element 78 of previous figures.

The method 200 comprises providing 202 a primary sheet, such as the primary sheet 80 of previous figures, having a primary first side and a primary second side. The primary sheet comprising fibres, e.g. the primary sheet may comprise fibres extending in a longitudinal direction and in a transverse direction. The primary sheet comprising a first fibre thread extending in a primary first direction and forming a first primary loop on the primary first side of the primary sheet from a primary first L1 point to a primary first L2 point, and wherein a first end of the first fibre thread is anchored to the primary sheet.

The primary sheet may comprise a second fibre thread extending in a primary second direction and forming a second primary loop on the primary first side of the primary sheet from a primary second L1 point to a primary second L2 point. The first fibre thread and the second fibre thread may extend substantially parallel, and wherein the second fibre thread is anchored to the primary sheet.

The method 200 optionally comprises providing 204 a pre-shaped element. The method optionally comprises positioning 206 the pre-shaped element on the primary sheet, e.g. between the first fibre thread and the second fibre thread, e.g. between the first primary loop and the second primary loop. A second pre-shaped element may be provided and arranged on top of the first pre-shaped element, alongside the first pre-shaped element in the longitudinal direction, or alongside the first pre-shaped element in the transverse direction. The pre-shaped elements may have different lengths, widths and thicknesses.

The method 200 comprises providing 208 a secondary sheet, such as the secondary sheet 100 as described with respect to previous figures. The secondary sheet comprises a first primary slit and optionally a second primary slit. The method 200 comprises arranging 210 the secondary sheet such that the first primary slit is aligned with the first primary loop and optionally such that the second primary slit is aligned with the second primary loop, and optionally such that the pre-shaped element is arranged between the primary sheet and the secondary sheet. The method 200 optionally comprises pulling 212 the first primary loop through the first primary slit in the secondary sheet and optionally pulling 214 the second primary loop through the second primary sit in the secondary sheet.

The method 200 optionally comprises providing 216 a first fibre strip and pulling 218 the first fibre strip through the first primary loop of the first fibre thread and/or the second primary loop of the second fibre thread. The strip may be fastened or tightened to retain the pre-shaped elements.

The part element may comprise the secondary sheet without the fibre strip for retaining the pre-shaped elements. The part element may comprise the fibre strip without the secondary sheet for retaining the pre-shaped elements. The part element may comprise both the secondary sheet and the fibre strip for retaining the pre-shaped elements.

The method 200 comprises transferring 220 the part element from a first position to a second position. The first position may be a pre-form mould. The second position may be a mould for manufacturing for example a spar beam or a mould for manufacturing a blade shell part.

Transferring 220 the part element may comprise attaching 222 a transportation structure to the first fibre thread and/or the second fibre thread, e.g. attaching the first primary loop and/or the second primary loop to hooks in the transportation structure.

Transferring 220 the part element may comprise arranging 224 the part element in a mould comprising an inclined surface, and wherein arranging the part element comprises aligning the part element on the inclined surface of the mould. Alternatively, the part element may be arranged 224 on a blade shell part in a blade shell mould.

The method 200 optionally comprises curing 226 the part element and/or a wind turbine blade part comprising the part element. The part element may be cured in the first position, e.g. In the pre-form mould, or in the second position, e.g. In the mould or the blade shell mould. The part element may be cured by infusing the part element with a resin. Infusion may be provided by vacuum assisted resin transfer moulding (VARTM), e.g. with the part element in an inclined position or a substantially horizontal position.

FIG. 16 is a block diagram of an exemplary method 300 for manufacturing a part element for a wind turbine blade, such as the part element 78 of previous figures.

The method 300 comprises providing 302 a primary sheet, such as the primary sheet 80 of previous figures, having a primary first side and a primary second side.

The method 300 further comprises providing 304 a first fibre thread extending in a primary first direction and forming a first primary loop on the primary first side of the primary sheet. The loop is formed to extend from a primary first L1 point at the primary first side of the primary sheet to a primary first L2 point at the primary first side. Providing 304 the first fibre thread includes anchoring 306 the first fibre thread, such as a first end of the first fibre thread, to the primary sheet.

The method 300 comprises providing 308 a second fibre thread extending in a primary second direction and forming a second primary loop on the primary first side of the primary sheet. The loop is formed to extend from a primary second L1 point at the primary first side of the primary sheet to a primary second L2 point at the primary first side. Providing 308 the second fibre includes anchoring 310 the second fibre thread to the primary sheet.

The method 300 further comprises providing 312 a first pre-shaped element and positioning 314 the first pre-shaped element between the first fibre thread and the second fibre thread. Further pre-shaped elements may be provided and arranged on top of the first pre-shaped element, alongside the first pre-shaped element in the longitudinal direction, or alongside the first pre-shaped element in the transverse direction. The first pre-shaped element, and optionally any further pre-shaped elements, may be provided 312 after the first fibre thread and/or the second fibre thread has been provided 304, 308, as illustrated

The method 300 optionally comprises providing 316 a secondary sheet, such as the secondary sheet 100 as described with respect to previous figures. The method 300 may further comprise arranging 318 the secondary sheet and the primary sheet such that the primary first side of the primary sheet is facing the secondary second side of the secondary sheet.

Positioning 314 the first pre-shaped element may comprise positioning the first pre-shaped element between the primary sheet and the secondary sheet. The secondary sheet and the primary sheet may be arranged 318 prior to positioning 314 the first pre-shaped element, i.e. the first pre-shaped element may be positioned 314 after arranging 318 the secondary sheet and the primary sheet.

The secondary sheet may comprise a first primary sit and/or a second primary slit. The secondary sheet and the primary sheet may be arranged 318 such that the first primary slit is aligned with the first primary loop and/or such that the second primary slit is aligned with the second primary loop. The method 300 optionally comprises pulling 320 the first primary loop through the first primary slit and/or pulling 322 the second primary loop through the second primary slit.

The method 300 optionally comprises providing 324 a first fibre strip and pulling 326 the first fibre strip through the first primary loop of the first fibre thread and/or the second primary loop of the second fibre thread. The strip may be fastened or tightened to retain the pre-shaped elements.

The method 300 optionally comprises transferring 328 the part element, such as the primary sheet, the first pre-shaped element, and optionally the secondary sheet of the part element, from a first position to a second position. The first position may be a pre-form mould. The second position may be a mould for manufacturing for example a spar beam or a mould for manufacturing a blade shell part. Transferring 328 the part element may comprise attaching 330 a transportation structure to the first fibre thread and/or the second fibre thread, e.g. attaching the first primary loop and/or the second primary loop to hooks in the transportation structure.

Transferring 328 the part element may comprise arranging 332 the part element in a mould comprising an inclined surface, and wherein arranging the part element comprises aligning the part element on the inclined surface of the mould. Alternatively, the part element may be arranged 332 on a blade shell part in a blade shell mould.

The method 300 optionally comprises curing 334 the part element and/or a wind turbine blade part comprising the part element. For example, the part element may be impregnated and/or infused with resin and the resin may be cured. The part element may be cured in the first position, e.g. In the pre-form mould, or in the second position, e.g. In the mould or the blade shell mould.

The part element may be cured by infusing the part element with a resin. Infusion may be provided by vacuum assisted resin transfer moulding (VARTM), e.g. with the part element in an inclined position or a substantially horizontal position.

Exemplary embodiments are disclosed in the following items:
1. A part element for a wind turbine blade, the part element comprising a primary sheet having a primary first side and a primary second side, the primary sheet comprising a first fibre thread extending in a primary first direction and forming a first primary loop on the primary first side of the primary sheet from a primary first L1 point to a primary first L2 point, and wherein a first end of the first fibre thread is anchored to the primary sheet.
2. Part element according to item 1 comprising a secondary sheet, wherein the secondary sheet comprises a first primary slit extending in a secondary first direction from a secondary first L1 point to a secondary first L2 point.
3. Part element according to item 2, wherein the primary sheet and the secondary sheet is arranged such that the primary first L1 point of the primary sheet is aligned with the secondary first L1 point of the secondary sheet and the primary first L2 point of the primary sheet is aligned with the secondary first L2 point of the secondary sheet, and wherein the first primary slit is configured to receive part of the first fibre thread.
4. Part element according to any of the preceding items wherein the primary sheet comprises a second fibre thread extending in a primary second direction and forming a second primary loop on the primary first side of the primary sheet from a primary second L1 point to a primary second L2 point, the first fibre thread and the second fibre thread extending substantially parallel, and wherein a first end of the second fibre thread is anchored to the primary sheet.
5. Part element according to any of the preceding items, wherein the first fibre thread extends on the primary second side of the primary sheet from the primary first L1 point to a primary first L0 point, and extends on the primary second side of the primary sheet from the primary first L2 point to a primary first L3 point.
6. Part element according to any of the preceding items, wherein the second fibre thread extends on the primary second side of the primary sheet from the primary second L1 point to a primary second L0 point, and extends on the primary second side of the primary sheet from the primary second L2 point to a primary second L3 point.
7. Part element according to any of the preceding items, wherein the secondary sheet comprises a second primary slit, and wherein the second primary slit extends from a secondary second L1 point to a secondary second L2 point, and wherein the second primary slit is configured to receive part of the second fibre thread.
8. Part element according to any of the preceding items comprising a first pre-shaped element, such as a first pultruded strip, arranged between the first fibre thread and the second fibre thread.
9. Part element according to any of the preceding items comprising a second pre-shaped element, such as a second pultruded strip, arranged between the first fibre thread and the second fibre thread and aligned with the first pre-shaped element.
10. Part element according to any of the preceding items, wherein the primary sheet comprises a third fibre thread extending in a primary third direction and forming a third primary loop on the primary first side of the primary sheet from a primary third T1 point to a primary third T2 point, and wherein the primary third direction is different than the primary first direction and the primary second direction.
11. Part element according to any of the preceding items, wherein the secondary sheet comprises a third primary slit extending from a secondary third T1 point to a secondary third T2 point, wherein the third slit is configured to receive part of the third fibre thread.
12. A method for manufacturing a part element for a wind turbine blade, the method comprising providing a primary sheet having a primary first side and a primary second side, the primary sheet comprising a first fibre thread extending in a primary first direction and forming a first primary loop on the primary first side of the primary sheet from a primary first L1 point to a primary first L2 point, and wherein a first end of the first fibre thread is anchored to the primary sheet.
13. Method according to item 12 wherein the primary sheet comprises a second fibre thread extending in a primary second direction and forming a second primary loop on the primary first side of the primary sheet from a primary second L1 point to a primary second L2 point, the first fibre thread and the second fibre thread extending substantially parallel, and wherein the second fibre thread is anchored to the primary sheet.
14. Method according to item 13 comprising, e.g. after providing the primary sheet:
   providing a pre-shaped element, and
   positioning the pre-shaped element on the primary sheet between the first fibre thread and the second fibre thread.
15. Method according to item 14 comprising:
   providing a secondary sheet comprising a first primary slit and a second primary slit,
   arranging the secondary sheet such that the first primary slit is aligned with the first primary loop and the second primary slit is aligned with the second primary loop, and such that the pre-shaped element is arranged between the primary sheet and the secondary sheet,
   pulling the first primary loop through the first primary slit in the secondary sheet, and
   pulling the second primary loop through the second primary slit in the secondary sheet.
16. Method according to any of items 13-15 comprising
   providing a first fibre strip, and
   pulling the first fibre strip through the first primary loop of the first fibre thread and the second primary loop of the second fibre thread.
17. Method according to any of items 12-16 comprising transferring the part element from a first position to a second position, wherein transferring the part element comprises attaching a transportation structure to the first fibre thread and/or the second fibre thread.
18. Method according to item 17 wherein transferring the part element comprises arranging the part element in a mould comprising an inclined surface, and wherein arranging the part element comprises aligning the part element on the inclined surface of the mould.
19. Method according to any of items 12-18 comprising curing the part element.
20. A wind turbine blade comprising a part element according to any of items 1-11, wherein the part element is connecting a first blade section and a second blade section of the wind turbine blade.
21. Wind turbine blade according to Item 20 wherein the first blade section extends along a longitudinal axis from a root to a first end and the second blade section extends along the longitudinal axis from a second end to a tip, the first blade section comprising a root region, and a first airfoil region, the second blade section comprising a second airfoil region with the tip,
   the part element forming a spar beam connecting the first blade section and the second blade section, the spar beam longitudinally extending along a spar beam axis from a first beam position to a second beam position and being positioned such that the first beam position is located in the first airfoil region and the second beam position is located in the second airfoil region and a third beam position, between the first beam position and the second beam position, is aligned with the second end of the second blade section.

The invention has been described with reference to preferred embodiments. However, the scope of the invention is not limited to the illustrated embodiments, and alterations and modifications can be carried out without deviating from the scope of the invention.

### LIST OF REFERENCES

2 wind turbine
4 tower
6 nacelle
8 hub
10 blade
14 blade tip
15 tip end
16 blade root
17 root end
18 leading edge
20 trailing edge
24 first blade shell part (pressure side)
26 second blade shell part (suction side)
28 bond lines/glue joints
30 root region
32 transition region
34 airfoil region
34a first airfoil region
34b second airfoil region
40 shoulder
42 shear web or spar side
44 first blade section
46 second blade section
48 spar beam
50 first end
52 second end
60 pultruded member
62 biax element
74 first spar cap
76 second spar cap
78 part element
78′ part element
80 primary sheet
82 primary first side
84 primary second side
86 fibre thread
86′ first fibre thread
86″ second fibre thread
86′″ third fibre thread
86″″ fourth fibre thread
86′″″ fifth fibre thread
88′ primary first direction
88″ primary second direction
88″ primary third direction
90 primary loop
90′ first primary loop
90″ second primary loop
90′″ third primary loop
90″″ fourth primary loop
90′″″ fifth primary loop
91 loop
92′ first end of first fibre thread
92″ first end of second fibre thread
92′″″ first end of fifth fibre thread
100 secondary sheet
101A secondary first side
101B secondary second side
102 primary slit
102′ first primary slit
102″ second primary slit
102′″ third primary slit
102″″ fourth primary slit
102′″″ fifth primary slit
103 slit
108′ secondary first direction
120 fibre strip
122 pre-shaped element
122′ first pre-shaped element
122″ second pre-shaped element
122′″ third pre-shaped element
124 first column
126 second column
130 secondary loop
130′ first secondary loop
130″ second secondary loop
130″″ fifth secondary loop
132 first secondary slit
132′ second secondary slit
132″″ fifth secondary slit
134 stitch
136 spacing
140 transportation structure
150 mould
152 pre-form mould
154 blade shell mould
PFL0 primary first L0 point
PFL1 primary first L1 point
PFL2 primary first L2 point
PFL3 primary first L3 point
SFL1 secondary first L1 point
SFL2 secondary first L2 point
PSL1 primary second L1 point
PSL2 primary second L2 point
SSL1 secondary second L1 point
SSL2 secondary second L2 point
PTT1 primary third T1 point
PTT2 primary third T2 point
STT1 secondary third T1 point
STT2 secondary third T2 point
PFT1 primary fourth T1 point
PFT2 primary fourth T2 point
200 method
202 providing primary sheet
204 providing pre-shaped element
206 positioning pre-shaped element
208 providing secondary sheet
210 arranging secondary sheet
212 pulling first fibre thread through first primary slit
214 pulling second fibre thread through second primary silt
216 providing first fibre strip
218 pulling first fibre strip through first primary loop and second primary loop
220 transferring part element
222 attaching a transportation structure
224 arranging part element in mould
226 curing

1. A method for manufacturing a part element for a wind turbine blade, the method comprising:
providing a primary sheet having a primary first side and a primary second side,
providing a first fibre thread extending in a primary first direction and forming a first primary loop on the primary first side of the primary sheet extending from a primary first L1 point at the primary first side of the primary sheet to a primary first L2 point at the primary first side, including anchoring the first fibre thread to the primary sheet,
providing a second fibre thread extending in a primary second direction and forming a second primary loop on the primary first side of the primary sheet extending from a primary second L1 point at the primary first side of the primary sheet to a primary second L2 point at the primary first side, including anchoring the second fibre thread to the primary sheet, and
providing a first pre-shaped element, and
positioning the first pre-shaped element between the first fibre thread and the second fibre thread.

2. Method according to claim 1, wherein the first pre-shaped element is positioned after providing the first fibre thread and/or the second fibre thread.

3. Method according to claim 1 wherein the first fibre thread and the second fibre thread is provided such that the primary first direction and the primary second direction are parallel.

4. Method according to claim 1 comprising:
providing a secondary sheet having a secondary first side and a secondary second side, and
arranging the secondary sheet and the primary sheet such that the primary first side is facing the secondary second side,
wherein the first primary loop is provided to extend to the secondary first side of the secondary sheet, and the second primary loop is provided to extend to the secondary first side of the secondary sheet, and
wherein positioning the first pre-shaped element comprises positioning the first pre-shaped element between the primary sheet and the secondary sheet.

5. Method according to claim 4 wherein the secondary sheet comprises a first primary slit extending in a secondary first direction from a secondary first L1 point to a secondary first L2 point, and wherein arranging the primary sheet and the secondary sheet includes arranging the primary sheet and the secondary sheet such that the first primary slit is aligned with the first primary loop, and wherein the first primary loop is provided to extend to the secondary first side of the secondary sheet by pulling the first primary loop through the first primary slit in the secondary sheet.

6. Method according to claim 4 wherein the secondary sheet comprises a second primary slit extending in a secondary second direction from a secondary second L1 point to a secondary second L2 point, and wherein arranging the primary sheet and the secondary sheet includes arranging the primary sheet and the secondary sheet such that the second primary slit is aligned with the second primary loop, and wherein the second primary loop is provided to extend to the secondary first side of the secondary sheet by pulling the second primary loop through the second primary slit in the secondary sheet.

7. Method according to claim 1 comprising
providing a first fibre strip, and
pulling the first fibre strip through the first primary loop of the first fibre thread and the second primary loop of the second fibre thread.

8. Method according to claim 1 comprising transferring the primary sheet, the first pre-shaped element, and optionally the secondary sheet, from a first position to a second position, wherein transferring the primary sheet, the first pre-shaped element, and optionally the secondary sheet, comprises attaching a transportation structure to the first fibre thread and/or the second fibre thread.

9. Method according to claim 8 wherein transferring the primary sheet, the first pre-shaped element, and optionally the secondary sheet, comprises arranging the primary sheet, the first pre-shaped element, and optionally the secondary sheet, in a mould comprising an inclined surface, and wherein arranging the primary sheet, the first pre-shaped element, and optionally the secondary sheet, comprises aligning the part element on the inclined surface of the mould.

10. Method according to claim 1 wherein the primary sheet, the first pre-shaped element, and optionally the secondary sheet, are impregnated or infused with a resin and the method comprising curing the resin.

11. A part element for a wind turbine blade, the part element comprising a primary sheet having a primary first side and a primary second side,
the part element comprising a first fibre thread extending in a primary first direction and forming a first primary loop on the primary first side of the primary sheet extending from a primary first L1 point to a primary first L2 point at the primary first side, and wherein the first fibre thread is anchored to the primary sheet,
the part element comprising a second fibre thread extending in a primary second direction and forming a second primary loop on the primary first side of the primary sheet extending from a primary second L1 point at the primary first side of the primary sheet to a primary second L2 point at the primary first side, and wherein the second fibre thread is anchored to the primary sheet, and
wherein a first pre-shaped element is positioned between the first fibre thread and the second fibre thread.

12. Part element according to claim 11 wherein the first pre-shaped element is a first pultruded element, such as a first pultruded strip.

13. Part element according to claim 11 wherein the primary first direction and the primary second direction are substantially parallel.

14. Part element according to claim 11 comprising a secondary sheet having a secondary first side and a secondary second side, and wherein the secondary sheet and the primary sheet are arranged such that the primary first side is facing the secondary second side, and wherein the first primary loop extends on the secondary first side of the secondary sheet, and the second primary loop extends on the secondary first side of the secondary sheet, and wherein the first pre-shaped element is positioned between the primary sheet and the secondary sheet.

15. Part element according to claim 11 wherein the secondary sheet comprises a first primary slit extending in a secondary first direction from a secondary first L1 point to a secondary first L2 point, and wherein the primary sheet and the secondary sheet are arranged such that the first primary slit is aligned with the first primary loop, and wherein the first primary loop extends through the first primary slit.

16. Part element according to claim 11 wherein the secondary sheet comprises a second primary slit extending in a secondary second direction from a secondary second L1 point to a secondary second L2 point, and wherein the primary sheet and the secondary sheet are arranged such that the second primary slit is aligned with the second primary loop, and wherein the second primary loop extends through the second primary slit.

17. Part element according to claim 15 wherein the secondary first direction and the secondary second direction are substantially parallel.

18. Part element according to claim 11, wherein the first fibre thread extends on the primary second side of the primary sheet from the primary first L1 point to a primary first L0 point, and extends on the primary second side of the primary sheet from the primary first L2 point to a primary first L3 point.

19. Part element according to claim 11, wherein the second fibre thread extends on the primary second side of the primary sheet from the primary second L1 point to a primary second L0 point, and extends on the primary second side of the primary sheet from the primary second L2 point to a primary second L3 point.

20. Part element according to claim 11 comprising a second pre-shaped element, such as a second pultruded element, arranged between the first fibre thread and the second fibre thread and aligned with the first pre-shaped element.

21. Part element according to claim 11 comprising a third fibre thread extending in a primary third direction and forming a third primary loop on the primary first side of the primary sheet from a primary third T1 point to a primary third T2 point, and wherein the primary third direction is different than the primary first direction and/or the primary second direction.

22. Part element according to claim 21, wherein the secondary sheet comprises a third primary slit extending from a secondary third T1 point to a secondary third T2 point, and wherein the third primary loop extends through the third primary slit.

23. A wind turbine blade comprising a part element according to claim 11, wherein the part element is connecting a first blade section and a second blade section of the wind turbine blade.

24. Wind turbine blade according to claim 23 wherein the first blade section extends along a longitudinal axis from a root to a first end and the second blade section extends along the longitudinal axis from a second end to a tip, the first blade section comprising a root region, and a first airfoil region, the second blade section comprising a second airfoil region with the tip,
the part element forming a spar beam connecting the first blade section and the second blade section, the spar beam longitudinally extending along a spar beam axis from a first beam position to a second beam position and being positioned such that the first beam position is located in the first airfoil region and the second beam position is located in the second airfoil region and a third beam position, between the first beam position and the second beam position, is aligned with the second end of the second blade section.
